(19) United States
(12) Patent Application Publication
(10) Pub. No.: US 2010/0034649 A1
(43) Pub. Date: Feb. 11, 2010

(54) DEVICE FOR ENHANCING THE EFFECTIVENESS OF POWER CONVERSION FROM WIND AND OTHER FLUIDS

(76) Inventor: Derek Alan Taylor, Buckinghamshire (GB)

Correspondence Address: Derek Taylor, 85 Waterside, Peartree Bridge, Milton Keynes, MK6 3DE, GB

(21) Appl. No.: 12/306,652

(22) PCT Filed: Jun. 26, 2007
(86) PCT No.: PCT/GB07/02395

§ 371 Date: Dec. 24, 2008

(30) Foreign Application Priority Data
Jun. 27, 2006 (GB) 0612677.5

(51) Int. Cl. F03D 3/04; F03B 17/06

(52) U.S. Cl. 415/208.1

(57) ABSTRACT

An energy enhancing device for increasing the effectiveness of energy conversion from wind and other fluid flows is presented by improving methods of accelerating the fluid flow passing through a turbine device or energy converter. Their main application is for accelerating the speed of fluid flow for fluid turbines and other devices designed to extract power from winds, induced air currents, river, ocean, tidal and other water currents.

### TECHNICAL FIELD

This invention relates to an energy enhancing device for increasing the effectiveness of energy conversion from wind and other fluid flows by improving methods of accelerating the fluid flow passing through a turbine device or energy converter. This invention's main applications are for:—
1. enhancing the energy extraction and improving the acceleration of the speed of wind flow or fluid flow for fluid turbines designed to extract power from winds, induced air movements, induced fluid movements, river currents, ocean currents, tidal currents and other water currents
2. floating energy converters for extracting power from winds, river currents, ocean currents, tidal currents and other water currents
3. building-integrated wind power provision
4. building-augmented wind power provision
5. wind powered heating
6. wind powered pumps
7. wind powered desalination
8. wind powered hydrogen production
9. wind powered greenhouses
10. wind powered bridges
11. wind powered signage displays
12. wind powered street lighting
13. wind powered railway systems
14. wind powered charging points/parking stations for electric vehicles
15. wind powered re-filling points/parking stations for hydrogen or compressed air vehicles
16. hybrid wind turbine driven and sail propelled surface vehicles
17. wind powered indirectly driven surface and near surface vehicles
18. onboard wind energy provision for recreation vehicles (RVs), caravans, boats and ships
19. hybrid wind and water current power exploitation for power provision for marine craft.

### BACKGROUND

Conventional wind turbines are generally designed to operate in the free air stream. The low density of air necessitates rather large rotating structures in order to capture large amounts of power. If the air stream (or fluid stream) velocity can be increased the turbine or wind or fluid energy converter can be reduced in size.

The device represents an improvement to augmentation methods for energy extraction performance of wind or fluid power conversion. This new invention includes a number of other variants.

### ADVANTAGES

This invention enhances energy extraction from wind and other fluid flows by means of power augmentation achieved by enhanced wind speed acceleration.

Compared to free-standing wind or fluid turbines or fluid energy converters, the power output from this device can be increased, productivity enhanced, the operating time extended and the energy output increased. These characteristics can potentially result in cost savings and increased abatement of carbon dioxide emissions compared to conventional energy methods.

This invention can be used to reduce the visibility of wind energy converters.

This invention facilitates the integration of wind energy conversion into buildings and other structures.

This invention improves the viability of utilising wind energy in low wind speed locations.

This invention improves the viability of utilising wind energy in urban areas.

This invention improves the viability of exploiting water currents in locations with low velocity water currents.

### INTRODUCTION AND DESCRIPTION OF DRAWINGS

In terms of this document the y-Axis refers to the longitudinal axis of the device, the z-Axis is the transverse lateral axis oriented at 90 degrees to the y-Axis and the x-Axis is oriented 90 degrees to the y-Axis and at 90 degrees to the z-Axis. The x/y Plane is the plane which is formed between the x-Axis and the y-Axis. The z/y Plane is the plane formed between the z-Axis and the y-Axis. The z/x Plane is the plane formed between the z-Axis and the x-Axis.

In terms of this document the definition of Dual-directional refers to the ability of the device to function as a wind or fluid energy conversion system with the wind flow or fluid flow entering the device from either side but its effectiveness is not necessarily the same in terms of energy capture. Dual-directional variants of the device include devices that are symmetric about the z-Axis of the device but not symmetric about the x-Axis. The Dual-directional variants act as a ‘fluid flow expander’ with the fluid-flow flowing from one side of the device relative to the x-y Plane or as a fluid-flow constrictor when the fluid flow is approaching from the other side of the device relative to the x-y Plane. In terms of this document the definition of Bi-directional refers to the ability of the device to function as a wind or fluid energy conversion system with the wind or fluid-flow entering the device from either side but its effectiveness is effectively the same in terms of energy capture. Bi-directional variants of the device include devices that are symmetric about the z-Axis of the device but also includes devices that are additionally symmetric about the x-Axis. In terms of this document the definition of Mono-directional refers to the ability of the device to function as a wind or fluid energy conversion system with the wind flow or fluid flow entering the device from one side but the direction of the Mono-direction can be fixed or it can be alterable by permitting the device to yaw or pitch (rotate) either about its y-Axis or about its x-Axis such that its effectiveness can be maintained when the direction of wind or fluid-flow approaching the device changes.

In terms of this document the definition of Multi-directional refers to the ability of the device to function as a wind energy or fluid energy conversion system with the wind or fluid-flow entering the device from a range of azimuth directions including up to 360 degrees of azimuth directions. The effectiveness of the Multi-directional variants of the device is not necessarily the same in terms of energy capture for all azimuth directions. Multi-directional variants of the device are symmetric about the z-Axis of the device but not symmetric about the x-Axis.

FIG. 1 shows a family of new improved and enhanced mono-planar wind or fluid flow and energy enhancing linear members, 1, classed as Mono-directional linear wind or fluid flow and energy enhancers (fixed or yawable about the y-Axis or about the x-Axis and pitchable about either its x-Axis or its y-Axis) ((a) through to (d) and (h) plus (i) to (k)), Dual-directional linear fluid-flow expander/constrictor enhancers (fixed or yawable) ((a) through to (d) and (h) plus (i), (j) and (k), Bi-directional linear enhancers ((e), (f), (g) and (l)), multiple element linear enhancers, slotted linear enhancers, single and dual skin linear enhancers.

FIG. 1 shows examples of fluid-flow turbines or wind turbines, 2, that can be incorporated into the device including cylindrical cross-flow turbines with axes of rotation parallel to the y-Axis of the device as shown in (a), (d), (e), (f), (g), (h), (i) and (l). Cylindrical cross-flow turbines with aerofoil type blades will perform best but differential drag type cylindrical cross-flow turbines such as (f) can also be employed.

FIG. 1 shows other examples of fluid-flow turbines or wind turbines, 2, that can be incorporated into the device including axial flow turbines with axes of rotation largely parallel to the z-Axis of the device as shown in (b), (d), and (j). Propeller-type axial-flow turbines with aerofoil type blades will perform best but other types of axial-flow turbines or mixed-flow turbines can also be employed.

FIG. 1 shows further examples of fluid-flow turbines or wind turbines (2) that can be incorporated into the device including cylindrical cross-flow turbines with axes of rotation parallel to the x-Axis of the device as shown in (c) and (k). Cylindrical cross flow turbines with aerofoil type blades will perform best but differential drag type cylindrical cross flow turbines can also be employed.

FIG. 1 shows a family of new improved and enhanced mono-planar wind or fluid flow and energy enhancing linear members, 1, in which the linear fluid-flow enhancing members are configured such that the y-Axis is vertically aligned as in (a) through to (h) and (l), but they can configured such that the y-Axis is horizontally aligned as shown in (i), (j) and (k) or aligned with an angle in between vertical and horizontal.

FIG. 2 shows the cross sectional profiles (Section A-A of FIG. 1) of a family of new improved and enhanced mono-planar wind or fluid flow and energy enhancing linear members, 1, classed as Bi-directional linear fluid-flow enhancers. These include single element ((a) through to (o)) and multiple element variants ((p) through to (t)) all of which are symmetric about the x/y Plane. The fluid flow turbines or wind turbines, 2, shown adjacent to the linear members, 1, are cylindrical cross flow turbines but axial flow turbines can also be employed. Laterally symmetric variants are shown in (p), (q), (r), (s) and (t).

FIG. 3 shows the cross sectional profiles (Section A-A of FIG. 1) of a family of new improved and enhanced mono-planar enhancing linear members, 1, classed as Mono-directional or Dual-directional linear fluid-flow enhancers. These include single element variants ((a) through to (h)) and multiple element variants ((i) and (j)) all of which are asymmetric about the x/y Plane described by the x-Axis and the y-Axis. The fluid-flow turbines or wind turbines, 2, shown adjacent to the linear members, 1, are cylindrical cross flow turbines but axial-flow turbines can also be employed. An example of a vortex trapping cavity within an linear member is shown in (h).

FIG. 4 shows the cross sectional profiles (Section AA of FIG. 1) of a family of new improved and enhanced mono-planar wind or fluid flow and energy enhancing linear members, 1, classed as Mono-directional or Dual directional linear fluid-flow enhancers. These are similar to profiles (a) to (h) and (i) to (o) shown in FIG. 2 except that they are set at a tilt angle or pitch angle greater than 0 degrees about a pitch axis parallel to the y-Axis shown in FIG. 1. These are single element variants all of which are symmetric about the x/y Plane when set at 0 degrees pitch angle. The fluid-flow turbines or wind turbines, 2, shown adjacent to the linear members, 1, are cylindrical cross flow turbines but axial-flow turbines can also be employed. Examples of vortex trapping cavities within linear members are shown in (i) and (k).

FIG. 5 shows a family of new improved and enhanced bi-planar enhancing linear members (1) classed as Mono-directional linear wind or fluid flow and energy enhancers (fixed or yawable about y-Axis or about its x-Axis and pitchable about either the x-Axis or the y-Axis) ((a) through to (h) and (j) through to (n)), Dual-directional linear fluid-flow expander/constrictor enhancers (fixed or yawable) ((a) through to (h) and (j) through to (n)), Bi-directional linear enhancers (i), multiple element linear enhancers ((e), (i) and (n)), slotted linear enhancers ((e), (i) and (n)), single and dual skin linear enhancers. These are all examples of Longitudinally symmetric variants and (i) is both Longitudinally symmetric and Laterally symmetric.

FIG. 6 shows the cross sectional profiles (Section A-A of FIG. 5) of a family of new improved and enhanced bi-planar enhancing linear members (1) classed as Bi-directional linear wind or fluid flow and energy enhancers. These include single element variants that are symmetric about the x/y Plane. They are also symmetric about the z/y Plane described by the z-Axis and the y-Axis. The fluid-flow turbines or wind turbines, 2, shown adjacent to and located between the linear members, 1, are cross-flow turbines but axial-flow turbines can also be employed. Examples of vortex trapping cavities within linear members are shown in (m) and (n).

FIG. 6: A further range of variants of bi-planar fluid-flow enhancers which can be used are dual sized bi-planar wind or fluid flow and energy enhancers similar to some of the variants illustrated in FIG. 6 can be achieved by the first fluid-flow enhancing linear member having physical dimensions larger than the second fluid-flow enhancing linear member. The second fluid-flow enhancing linear member could be of the same cross sectional profile shape yet physically smaller or the second fluid-flow enhancing linear member could have a different profile shape such as one of the fluid-flow enhancing linear members shown in FIG. 2 or FIG. 3 or FIG. 4 or in FIG. 9. Wind energy converters or turbines or fluid-flow energy converters or turbines are located between Side A of the first fluid-flow enhancing linear member and Side A of the second fluid-flow enhancing linear member. These dual sized bi-planar wind enhancers or fluid-flow enhancers can be classed as Bi-directional enhancers, Mono-directional enhancers or Dual-directional enhancers according to profile shapes and tilt angles. Dual sized bi-planar fluid-flow enhancers can be applied to horizontally aligned canopy roof structures in which the larger first fluid-flow enhancing linear member would form the canopy roof. This dual sized bi-planar canopy roof arrangement can be configured such that the first fluid-flow enhancing linear member is positioned below the second fluid-flow enhancing linear member and the turbines are located above the first fluid-flow enhancing linear member and below the second fluid-flow enhancing linear member. The dual sized bi-planar canopy roof arrangement could also be configured such that the first fluid-flow enhancing linear member is positioned above the second fluid-flow enhancing linear member and the turbines are located above the second fluid-flow enhancing linear member and below the first fluid-flow enhancing linear member.

FIG. 7 shows the cross sectional profiles (Section A-A of FIG. 5) of a family of new improved and enhanced bi-planar enhancing linear members, 1, classed as Mono-directional or Dual-directional linear wind or fluid flow and energy enhancers. These include single element variants ((a) through to (g)) and multiple element variants ((h) and (i))—all of which are asymmetric about the x/y Plane described by the x-Axis and the y-Axis. They are symmetric about the z/y Plane described by the z-Axis and the y-Axis. The fluid-flow turbines or wind turbines, 2, shown adjacent to and located between the linear members, 1, are cross-flow turbines but axial-flow turbines can also be employed. All the examples shown in FIG. 7 are Longitudinally symmetric variants.

FIG. 8 shows the cross sectional profiles (Section A-A of FIG. 5) of a family of new improved and enhanced bi-planar enhancing linear members, 1, classed as Bi-directional linear wind or fluid flow and energy enhancers. These include multiple element variants, all of which are symmetric about the x/y Plane described by the x-Axis and the y-Axis. They are also symmetric about the z/y Plane described by the z-Axis and the y-Axis. The fluid-flow turbines or wind turbines, 2, shown adjacent to and located between the linear members, 1, are cross flow turbines but axial flow turbines can also be employed. All the examples shown in FIG. 8 are both Longitudinally symmetric and Laterally symmetric variants.

FIG. 9 shows the cross-section profile shapes (based on Section A-A in FIG. 1 or FIG. 5) of a family ((a) through to (p)) of edge ‘flaps’ (3 through to 10) that can be applied to the trailing edge of Mono-directional linear wind or fluid flow and energy enhancers and to both the trailing edge and leading edge of the Bi-directional linear enhancers, Dual-directional linear enhancers and Multi-directional enhancers described in this invention to enhance the energy extraction by improving the effectiveness of the acceleration of fluid or wind velocities. These ‘flap’ devices include a hinged ‘aileron-type’ adjustable flap 3 shown in (a), fixed ‘aileron-type flap’ 4 shown in (b), perpendicular plate flap known as a ‘Gurney Flap’ or ‘Wicker Flap’ 5 shown in (c) and (d) and (e) and in (h), (i) and (o). Other types of ‘flaps’ or trailing edge treatments include a ‘fishtail profile edge’ 6 shown in (f) and in (m) and (p). Another type of flap includes one or more smaller flat plate shaped profiled members or curved plate shaped profiled members 8 and 9 located ‘behind’ the trailing edge in line with or at a small angle to the primary linear member with a gap or slot in between as shown in (i) and (j) to form a multiple element linear enhancing member. A similar ‘flap’ includes one or more flaps each with an aerofoil shape profile (7 and 10) located ‘behind’ the trailing edge of the primary linear member in line with or at a small angle to the primary linear member with a gap or slot in between as shown in (g), (h), (k), (l), (m), (n), (o) and (p) to form a multiple element linear enhancing member.

FIG. 9 also shows the cross-section profile shapes (based on Section A-A in FIG. 1 or FIG. 5) of a family of edge ‘slats’, 11, shown that can be applied (as shown in (k) to (p)) to the leading edge of Mono directional wind or fluid flow and energy enhancers and to both the trailing edge and leading edge of the Bi-directional enhancers or the Dual-directional enhancers or the Multi-directional enhancers described in this invention to enhance the energy extraction by improving the effectiveness of accelerating fluid velocity.

FIG. 10 shows a family of new improved and enhanced bi-planar enhancing linear members, 1, classed as Bi-directional linear wind or fluid flow and energy enhancers configured as mono-planar enhancers ((a) through to (e)) and bi-planar wind or fluid flow and energy enhancers ((f) through to (k)). These include multiple element variants, all of which are symmetric about the x/y Plane described by the x-Axis and the y-Axis. Examples (f) through to (k) are also symmetric about the z/y Plane described by the z-Axis and the y-Axis. The fluid-flow turbines or wind turbines, 2, shown adjacent to and between the linear members, 1, are cross-flow turbines but axial-flow turbines can also be employed. FIG. 10 shows examples of Laterally symmetric variants ((a), (b), (c), (d) and (e)) and examples of both Longitudinally symmetric and Laterally symmetric variants ((f), (g), (h), (i), (j) and (k)).

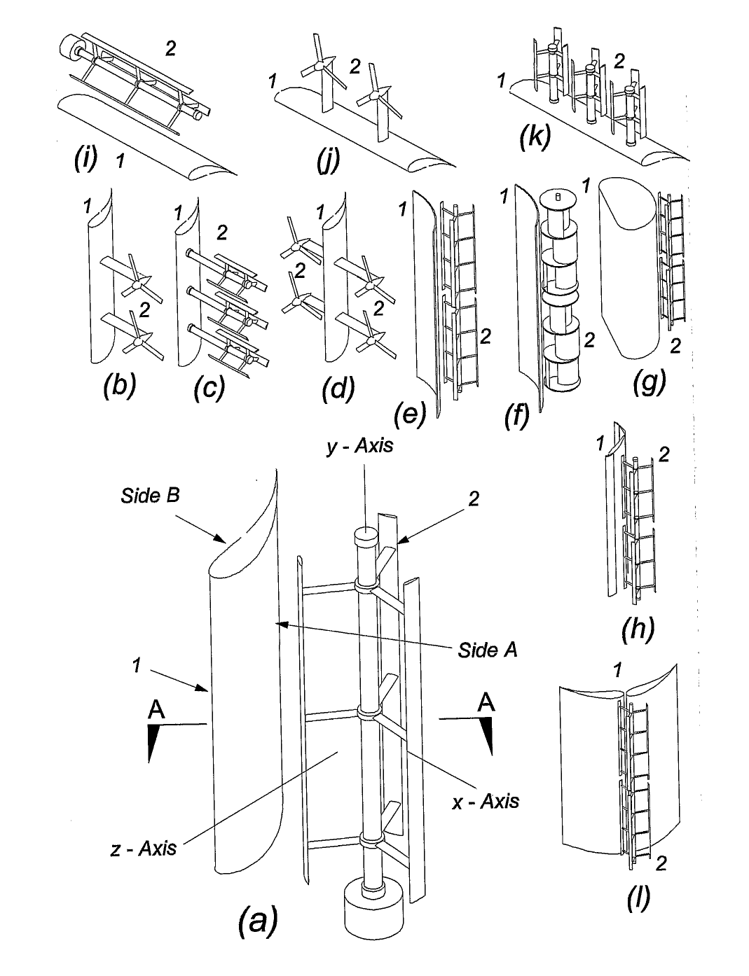

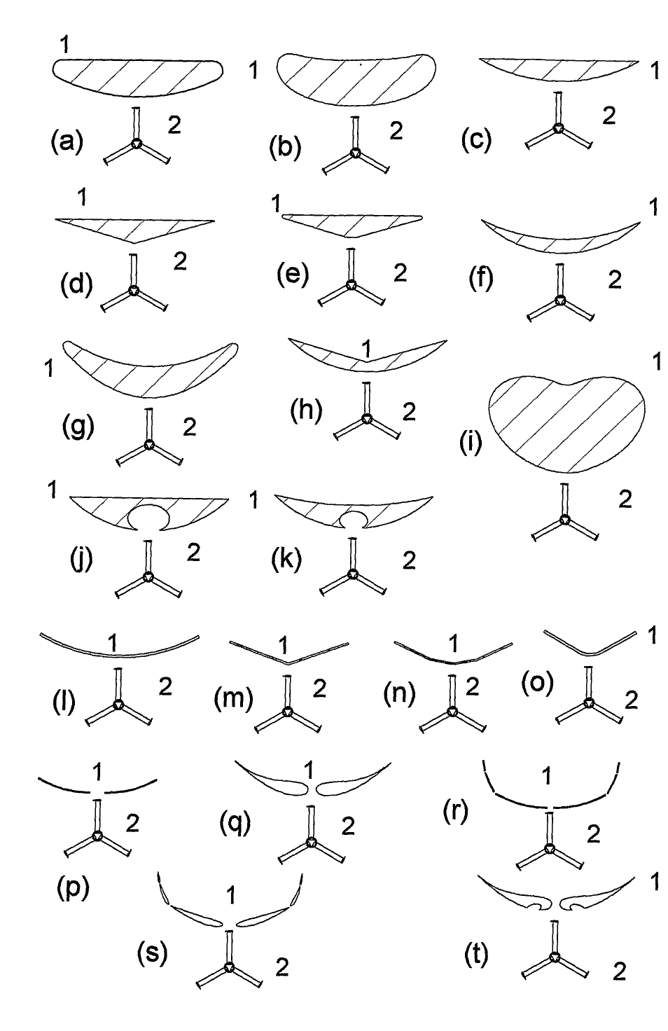

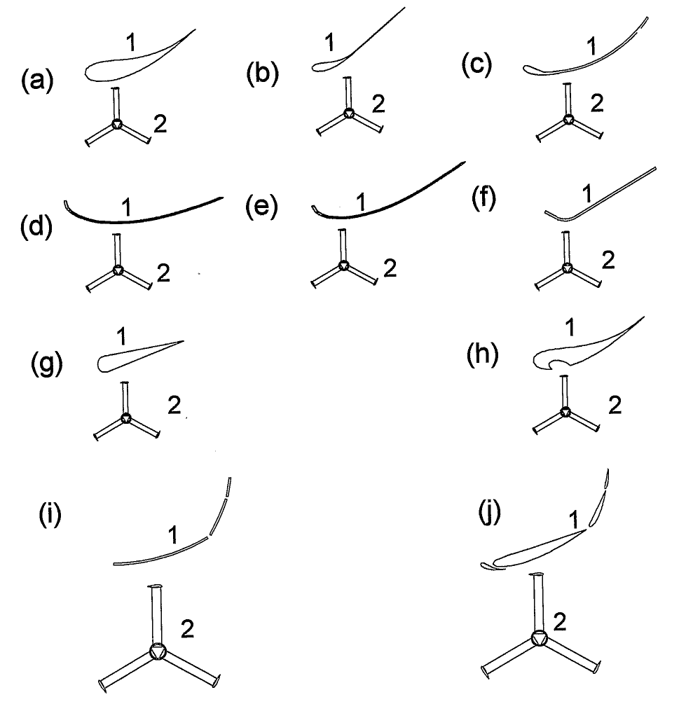

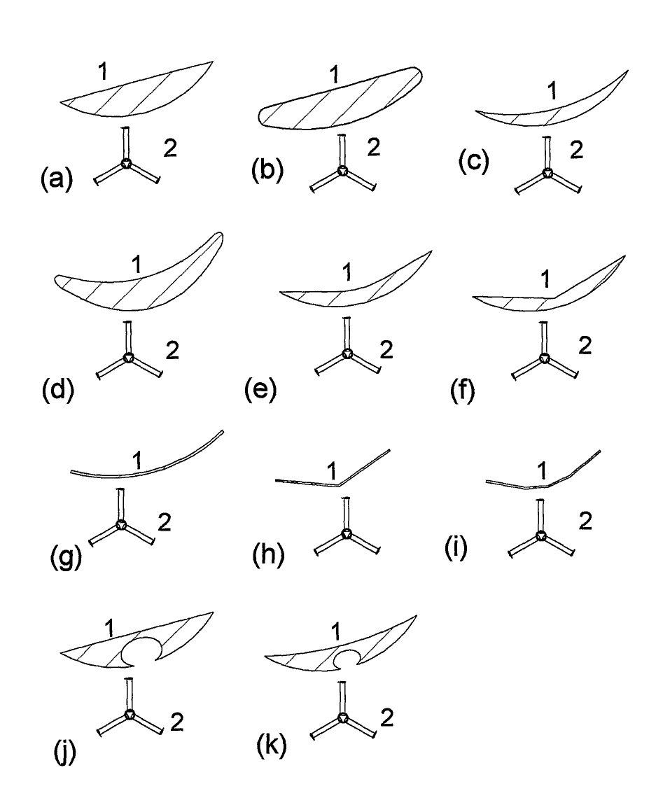

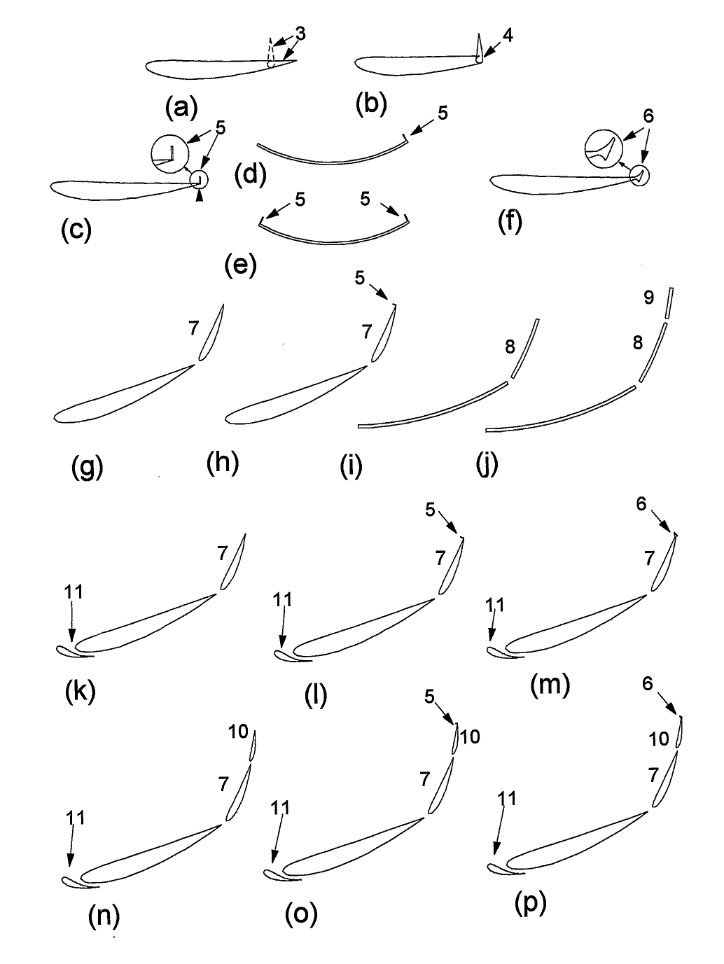

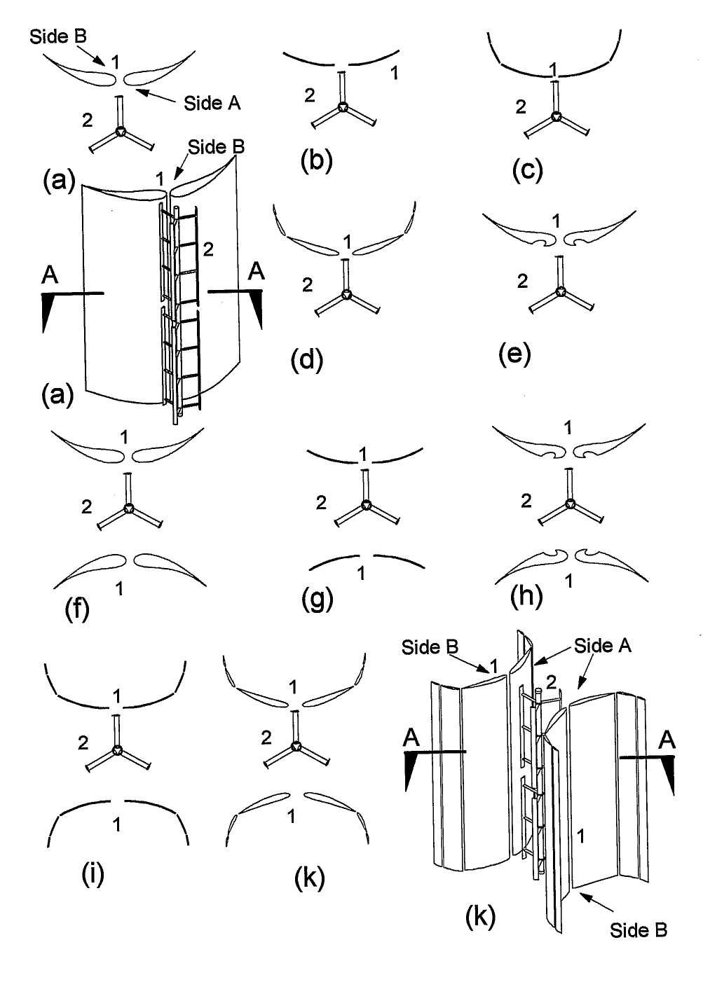

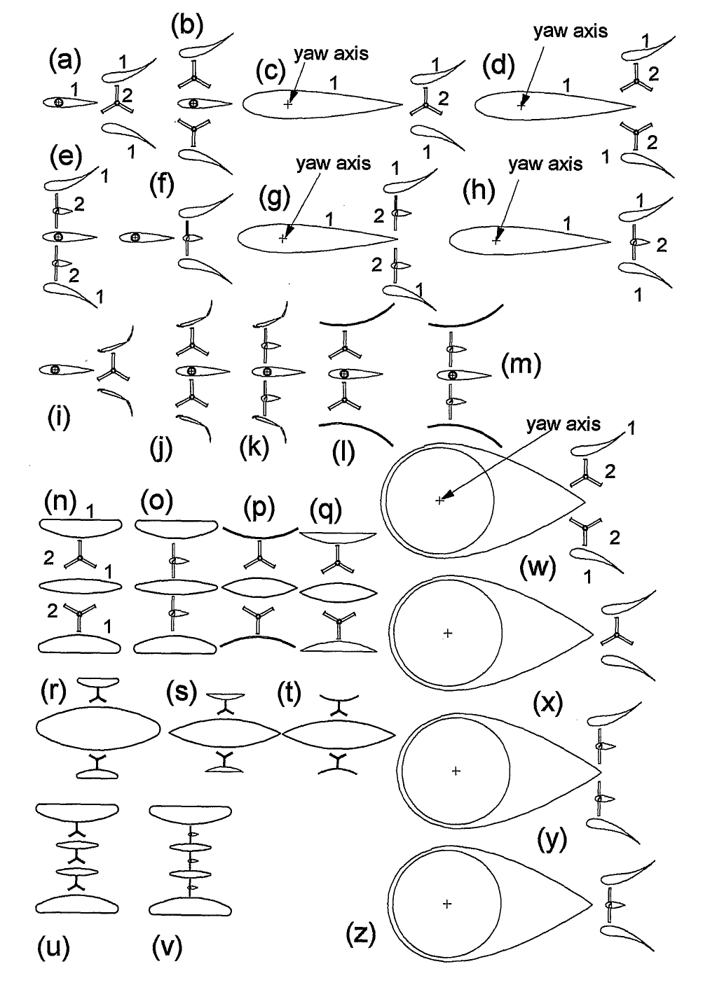

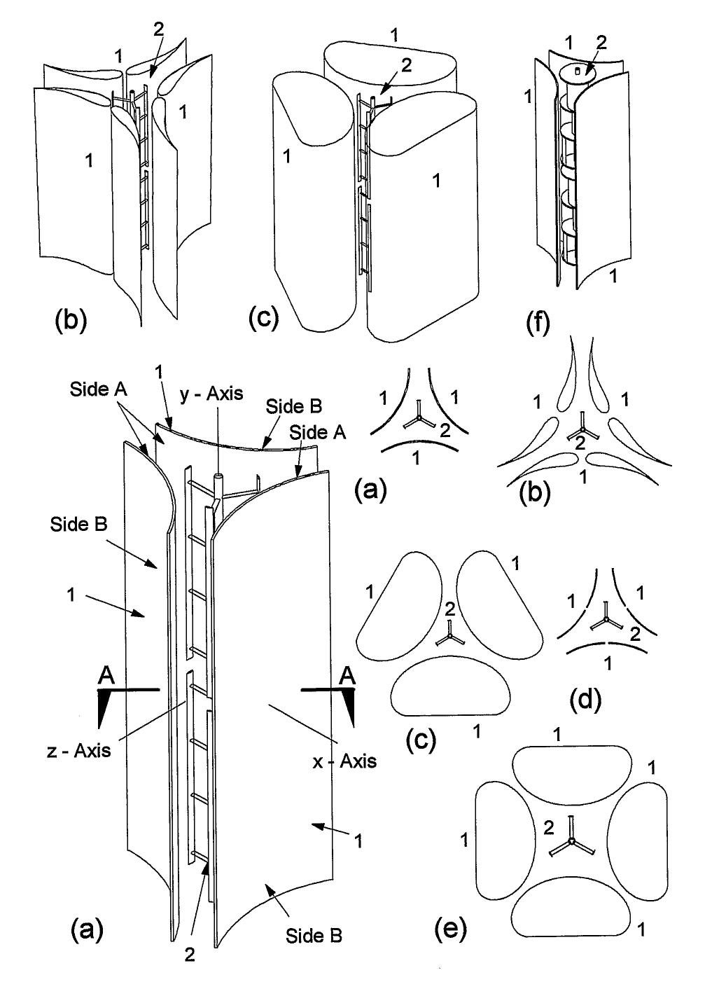

FIGS. 2 (j), 2 (k), 2(t), 3 (h), 4 (j), 4 (k), 6 (m), 6 (n), 7 (g), 8 (c) and 10 (h) show the cross-section profile shapes (based on Section A-A in FIG. 1 or FIG. 5) of linear wind or fluid flow and energy enhancing members that include a cavity or void designed to trap vortices to improve attached fluid flow performance to enhance the energy extraction by improving the effectiveness of accelerating fluid velocity.

FIGS. 1 (e), 1 (f), 2 (f), 2 (g) 2 (l), 3 (c), 3 (d), 3 (e), 4 (c), 4 (d), 4 (g), 5 (g) and 5 (h) shows a device comprising a wind or fluid flow and energy enhancer comprising one linear member with one convex surface and one concave surface.

FIGS. 5 (g), 5 (h), 6 (a), 6 (d), 6 (h), 6 (i), 7 (c), 7 (d), 7 (e), 8 (b), 10 (b) and 10 (g) shows a device comprising a wind or fluid flow and energy enhancer comprising two linear members each with one convex surface and one concave surface.

FIGS. 1 (g), 2 (a), 2 (c), 2 (l), 4 (a) and 4 (b) show a device comprising a wind or fluid flow and energy enhancer comprising one linear member with both one convex surface and one flat surface.

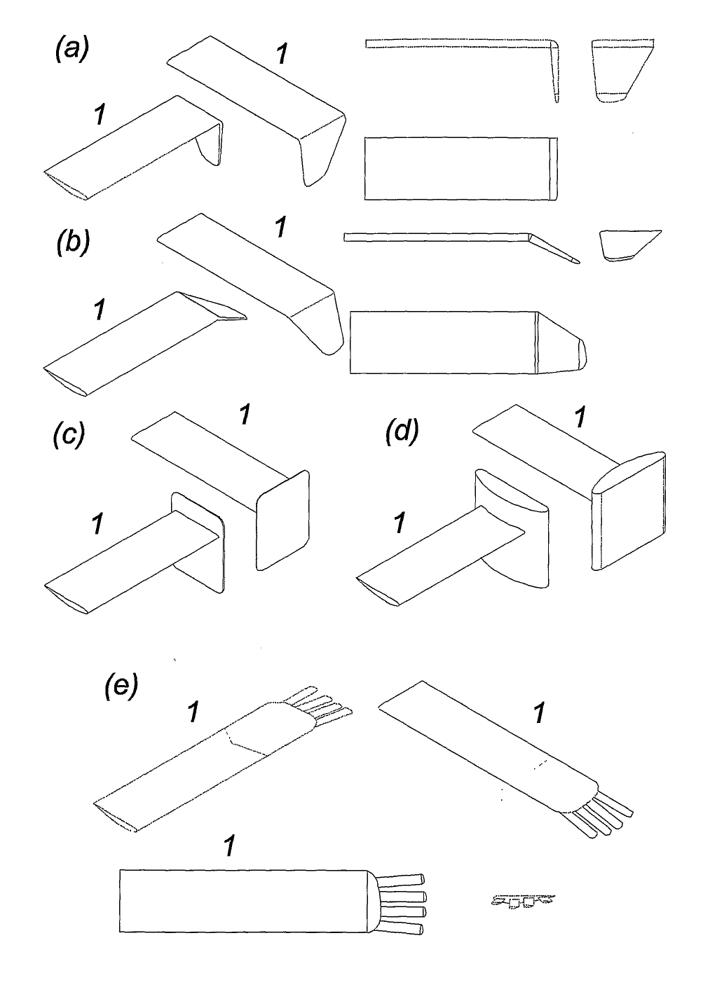

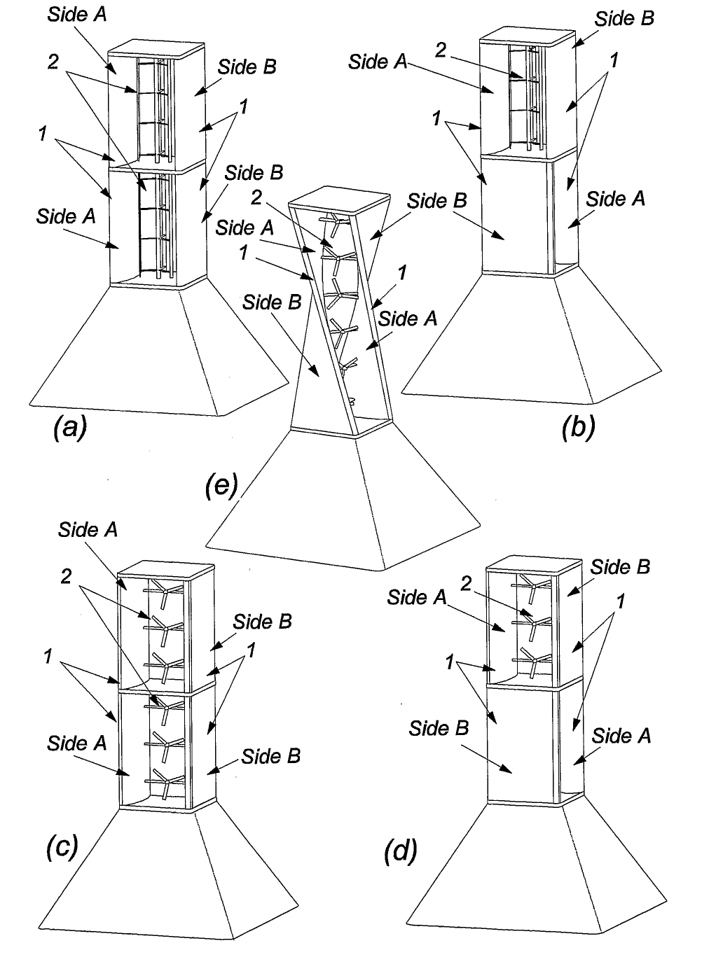

FIGS. 5 (f), 6 (b) and 6 (c) show a device comprising a wind or fluid flow and energy enhancer comprising two linear members each with both one convex surface and one flat surface.

FIGS. 1 (e), 1(f), 2 (p), 3 (c), 3 (d), 3 (e) and 4 (g) show a device comprising a wind or fluid flow and energy enhancer comprising one linear member consisting of a curved plate shaped profile.

FIGS. 5 (g) 5 (h), 6 (i), 7 (c) and 7 (d) show a device comprising a wind or fluid flow and energy enhancer comprising two linear members each consisting of a curved plate shaped profile.

FIGS. 1 (h), 2 (r), 2 (s), 3 (i), 3 (j), 9 (g), 9 (h), 9 (i), 9 (j), 9 (k), 9 (l), 9 (m), 9 (n), 9(o), 9 (p), 10 (c) and 10 (d) show examples of devices comprising a wind or fluid flow and energy enhancer comprising one linear member consisting of a number of self similar linear members.

FIGS. 5 (e), 5 (n), 5 (i), 7 (h), 7 (i), 8 (d) and 8 (e) show examples of devices comprising a wind or fluid flow and energy enhancer comprising two linear members each consisting of a number of self similar linear members.

FIGS. 1 (l), 2 (p), 2 (q), 2 (t), 10 (a), 10 (b) and 10 (e) show examples of device comprising a Bi-directional wind or fluid flow and energy enhancer comprising an linear member consisting of two ‘mirrored’ self similar linear members.

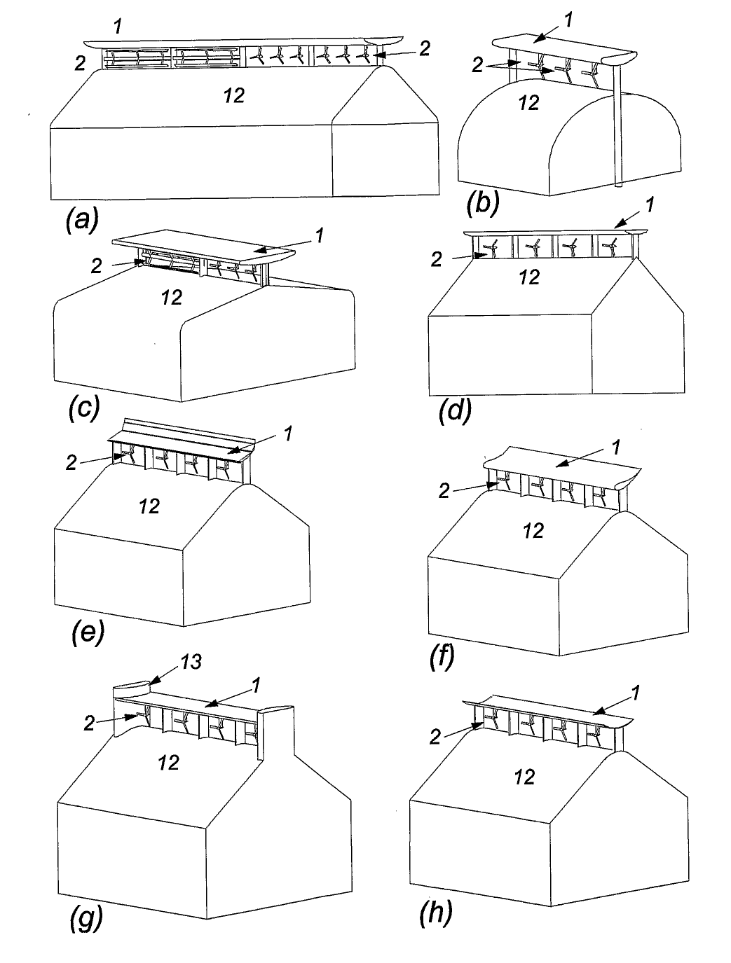

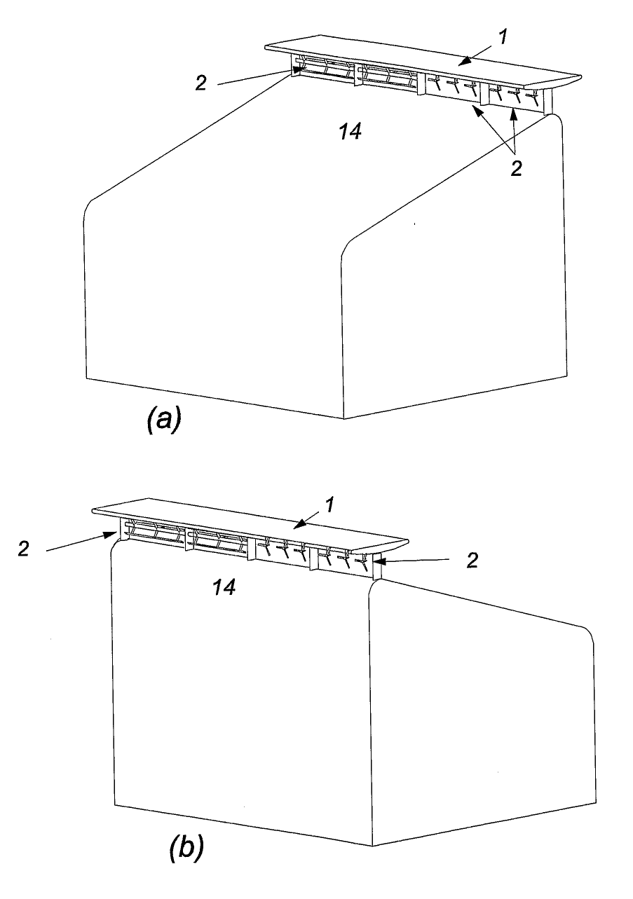

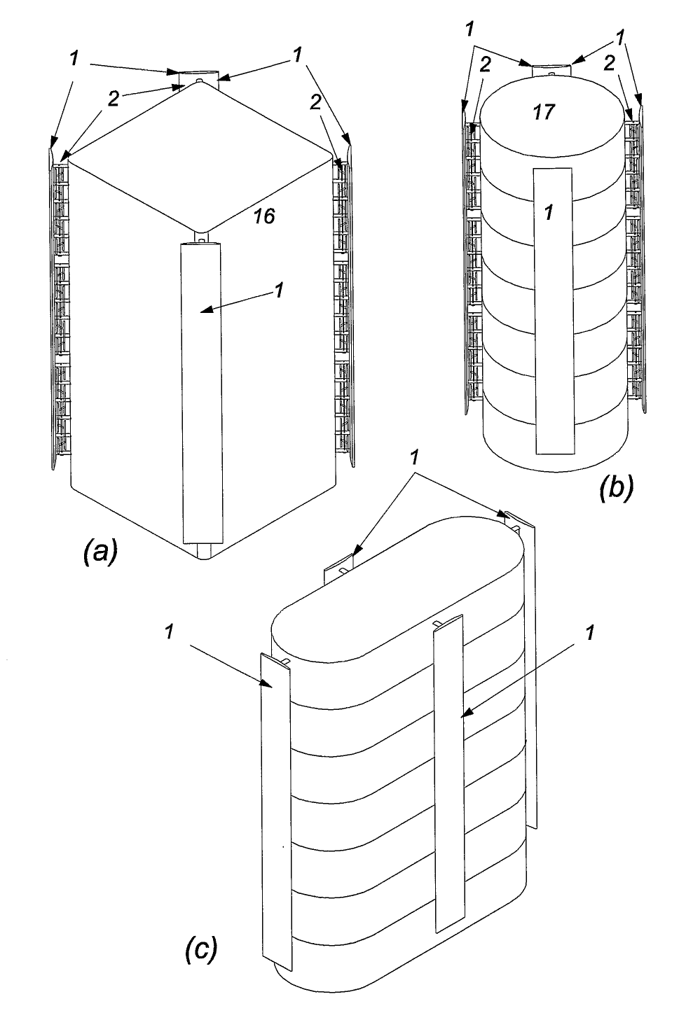

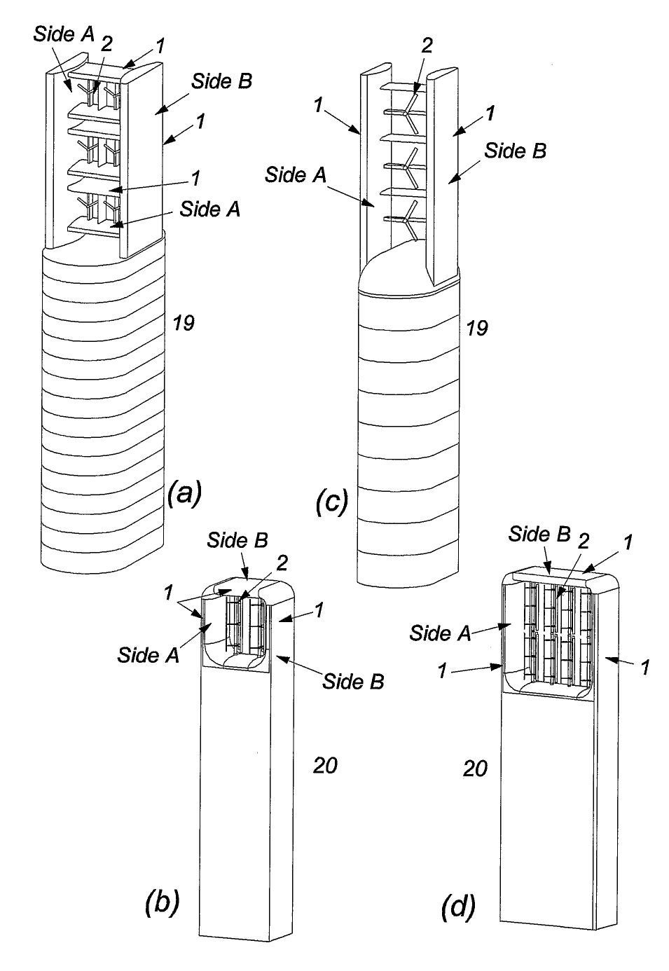

FIGS. 8 (a), 8 (b), 8 (c), 10 (f), 10 (g) and 10 (h) show examples of devices comprising a Bi-directional wind or fluid flow and energy enhancer comprising two linear members each consisting of two ‘mirrored’ self similar linear members.

FIG. 11 shows a range of end treatments and appendages ((a) through to (e)) that can be applied to the tips or ends of the linear members of linear wind or fluid flow and energy enhancers described in this invention to enhance the energy extraction by improving the effectiveness of the acceleration of fluid or wind velocities.

FIGS. 2 (r), 2 (s), 10 (c) and 10 (d) show examples of devices comprising a Bi-directional wind or fluid flow and energy enhancer comprising an linear member consisting of two ‘mirrored’ self-similar linear members each consisting of multiple elements.

FIGS. 5 (i), 8 (d), 8 (e), 10 (i) and 10 (k) show examples of devices comprising a Bi-directional wind or fluid flow and energy enhancer comprising two linear members each consisting of two ‘mirrored’ self similar linear members each consisting of multiple elements.

FIG. 12 shows a family of multi-staged modular wind or fluid flow and energy enhancers ((a) through to (d)) consisting of enhancing linear members configured as Bi-directional bi-planar wind or fluid flow and energy enhancers with one bi-planar module stacked one stage above the other. In the case of variants (a) and (c) the bi-planar enhancer stages are aligned to face the same fluid-flow directions or wind directions. In the case of variants (b) and (d) the upper stage module is oriented such that it receives fluid-flows or winds from directions at 90 degrees to the fluid-flow or wind directions received by the lower stage module. In the case of variant (e) the linear members are both shaped to follow a helical path with the convex surfaces facing each other and the fluid flow turbines located in between. In the case of variant (e) the fluid flow direction received by one turbine is slightly offset relative to the turbine immediately below it. In this way fluid flows from all compass directions can be exploited in variant (e) without the need for yawing of the device. Variants (a) and (b) show cross-flow turbines and variants (c), (d) and (e) show axial-flow turbines. Other options for modular bi-planar fluid flow enhancers include a three-stage variant with each stage module off-set by 120 degrees from the stage module below. These modules can additionally be combined together side by side to form a ‘wall’ or can be configured horizontally in a row or rows to form ‘parapet walls’ or higher ‘walls’ when joined in the manner of bricks in a brick wall.

FIG. 13 shows the cross section profile shapes (based on equivalent Section A-A as the Section A-A of FIG. 5) of a family of new improved and enhanced multi-planar enhancing linear members, 1, classed as vertically aligned or horizontally aligned Mono-directional linear wind or fluid flow and energy enhancers (fixed or yawable about a yaw axis parallel to the y-Axis or about a yaw axis parallel to the x-Axis and pitchable about either its x-Axis or its y-Axis) ((a) through to (m) plus (w), (x) (y) and (z)), Dual-directional linear fluid-flow expander/constrictor wind or fluid flow and energy enhancers (fixed or yawable) ((a) through to (m) plus (w), (x), (y) and (z)) and Bi-directional linear wind or fluid flow and energy enhancers ((n) to (v)). Variants (a), (f) and (i) are configured with three planar linear members, 1, with the two outer members located in a bi-planar arrangement each side of the fluid flow turbine or wind turbine, 2, and ‘downstream’ of the central planar linear member. Variants (c) and (h) are similar to variants (a), (f) and (i), except that the central planar linear member is larger than the two outer planar enhancing members. Variants (b), (e), (j), (k), and (m) are configured with three planar linear members, 1, with the two outer planar linear members aligned with the central planar linear member and one outer planar linear member acts as a bi-planar fluid-flow enhancer in combination with the central planar linear member and the other outer planar linear member acts as a bi-planar fluid-flow enhancer with the other side of the central planar linear member such that in the case of a horizontally aligned version it will consist of two sets of turbines in ‘rows’ and in the case of a vertically aligned versions it will consist of two sets of turbines in ‘columns’. Variants (d) and (g) are similar to variants (b), (e), (j), (k), and (m) in that a horizontal version would have two sets of turbines in ‘rows’ and a vertical version would have two sets of turbines in ‘columns’ but in this case the central planar linear member is larger than the two outer planar linear members and positioned ‘upstream’ of the two outer planar linear members and wind or fluid flow turbines. Variants (x) and (z) are similar to variants (c) and (h) except these variants have a much ‘thicker’ central planar linear member which encircles and ‘yaws’ around a host structure of circular plan or cross-section such as a cylindrical structure or building or tower or chimney type structure. Variants (w) and (y) are similar to variants (x) and (z) but in this case a vertically aligned version would have two ‘columns’ of fluid-flow turbines instead of one column of turbines and horizontally aligned versions would have two ‘rows’ of turbines instead of one row of turbines. Variants (n), (o), (p) and (q) are Bi-directional variants consisting of three planar linear members together with two ‘rows’ of fluid-flow turbines in the case of horizontally aligned versions or two ‘columns’ of fluid-flow turbines in the case of vertically aligned versions with each ‘row’ or ‘columns’ positioned between two planar linear members with the outer planar linear fluid-flow enhancing members consisting of mirrored versions of each other and the central planar linear members shown as symmetric about the x/y Plane and about the z/y Plane. Variants (r), (s) and (t) are similar to the Bi-directional variants (n), (o), (p), and (q) except that the central planar linear member is larger than the two outer planar linear members and could be a host structure such as a tower or building or bridge-like enhancing linear member and turbines may also be attached to and adjacent to one or more of the slopes of the roof or to the eaves or to the verge of the roof or to parapets or to hips of a roof or to one or more valleys of a roof or attached to roof-lights. Variants (a) to (d) and (g) to (h) show the fluid-flow enhancing linear members of the Bi-directional variants set at zero pitch or tilt angle (e.g. horizontal in the examples shown in FIG. 15) and Mono-directional or Dual-directional variants (e) and (f) show the fluid-flow enhancing linear member to be tilted to an optimum pitch angle (about its longitudinal axis) greater than plus or minus one degree from horizontal though all types can be configured to have an adjustable pitch angle arrangement. Members supporting the planar linear member can be positioned below the planar linear member as in variants (a) through to (f) and in (h) but the supports can extend above Side B of the fluid-flow enhancing linear member as shown in variant (g) and the support members can also be separate from the host building or object. The support member can also be shaped with a similar profile shape as that employed on the fluid-flow enhancing linear member. The variants illustrated show the flow enhancing linear members to be straight and non-tapered but where appropriate these members can also be tapered and/or shaped to follow a curved path or shaped to follow a helical path. The curved shaped host objects or roofs can be prismatic like a barrel vault type roof or ‘wave form’ roof or shaped with double curvature and the curved forms can be formed or approximated with faceted shaped surfaces. The dual-pitched examples shown in FIG. 15 have symmetric roof pitches or slope angles, but they can be configured with asymmetric roof pitches or slope angles. The curve roof example shown FIG. 15 has a symmetric curve shape but the curved shape can be asymmetric or formed by a combination of convex and concave curves or ‘French Curve’ shapes or ‘spline curve’ shapes. The roof profile shape could also be formed by a combination of sloping regions and curved regions. The dual pitch roofs can be formed by either or both roof pitches formed by more than one slope angle in the manner of the traditional ‘Mansard roof’. The dual pitch roofs can be formed by the roof slopes attached to the ground avoiding support walls in the manner of a prismatic A-Frame type roof. The dual pitch roofs can also be linked together in a ‘saw-tooth’ profile arrangement or ‘zig-zag’ profile arrangement or ‘north-light truss’ arrangement with the flow enhancing linear members and turbines attached to and aligned with the ‘ridges’ of the ‘saw-tooth’ roof shape. Other variants of dual pitch profile roofs and ‘saw tooth’ profile roofs can be configured such that the ridge line is shaped to follow a curved path and the attached fluid-flow enhancing linear member also shaped and aligned to follow a similar curved path or follow a curved path concentric with the ridge line curved path. The dual pitched and curved roofs can also be configured as canopy roofs or pergola roofs or ‘Dutch barn’ type roofs or loggia roofs or gazebo roofs or shelter roofs or walkway roofs or tent roofs or membrane roofs. The dual-pitched or curved profile host objects can also be formed as earth mounds or earth berms or ‘green roofs’ or small ‘hill-like’ objects or walls or fences or wind-breaks or appropriately shaped reinforced concrete structures or mass concrete structures or other structures designed for other purposes such as dams, sea walls, harbour walls, buttress walls, flood protection walls and noise barrier walls etc. The dual-pitched or dual sloped host objects can also be in the form of walls with steeply inclined slope angles close to vertical or even vertical in the case of walls with narrow cross sectional width relative to wall height.

FIGS. 15 (a), 15 (b), 15 (c), 15 (d) and 15 (g) show examples of devices comprising a wind or fluid flow and energy enhancer comprising a linear member consisting of one convex surface and one flat surface positioned adjacent to a roof top.

FIG. 15: An extension of the dual pitch roof approach described and illustrated in FIG. 15 and applied to multi-pitched or multi-sided roofs provides a number of additional variants that can be formed by the roof slopes converging together at a point or pinnacle with the roof slopes either attached to the ground or on support walls in the manner of a turret-type roof. In this arrangement the roof takes the form of a tripod roof or pyramid roof or a five or six sided pointed roof etc. In this arrangement inclined versions of the fluid-flow enhancing linear members and turbines are attached to and aligned with one or more of the ‘hip’ line edges of the roof in the manner of a sloping version of the ridge mounted arrangement illustrated in FIG. 15. A similar variant based on a conical roof would involve one or more sets of fluid-flow enhancing linear members and turbines aligned with the inclined surfaces of the conical roof.

FIG. 16 shows two views of an example of a family of new roof-mounted or object-mounted wind or fluid flow and energy enhancing enhancing linear members, 1, configured as Bi-directional enhancers ((a) and (b)) attached (together with wind energy converters or turbines or fluid-flow energy converters or turbines) to mono-pitched roof shapes, 14, or to other single sloped objects such that Side A of the fluid-flow enhancing linear member faces towards the host object or roof surface. The variants illustrated show the fluid-flow enhancing linear member and turbines attached to the ridge or uppermost region of the roof but the fluid-flow enhancing linear member and turbines may also be attached to one or more of the slopes of the roof or host object or to the eaves or to the verge of the roof or to parapets or to hips of a roof or attached to roof-lights. Variants (a) to (b) show the fluid-flow enhancing linear members of the Bi-directional variants set at zero pitch or tilt angle (e.g. horizontal in the example shown) but Mono-directional or Dual-directional variants the fluid-flow enhancing linear members are tilted to an optimum pitch angle greater than plus or minus one degree from horizontal or variants with an adjustable pitch angle can be employed. Members supporting the fluid-flow enhancing linear member can be below the fluid-flow enhancing linear member as in variants (a) and (b) but the supports can extend above Side B of the linear flow enhancing member and the support members can also be separate from the host building or object. The support member can also be shaped with a similar profile shape as that employed on the fluid-flow enhancing linear member. The variants illustrated show the linear flow-enhancing members to be straight and non-tapered but where appropriate these members can also be tapered and/or shaped to follow a curved path or follow a helical path. The roof profile shape could also be formed by a combination of sloping regions and curved regions. The mono-pitch roofs can be formed by the roof pitch being formed by more than one slope angle in the manner of a mono-pitch variant of the traditional ‘Mansard roof’. The mono-pitch roofs can be formed by the roof slope attached to the ground avoiding support walls in the manner of a prismatic wedge shaped roof. Other variants of the mono-pitch profile roofs can be configured such that the ridge line is shaped to follow a curved path and the attached fluid-flow enhancing linear member also shaped and aligned to follow a similar curved path or follow a curved path concentric with the ridge line curved path. The mono-pitched roofs can also be configured as canopy roofs or pergola roofs or ‘Dutch barn’ type roofs or loggia roofs gazebo roofs or shelter roofs or tent roofs or membrane roofs. The mono pitched profile host objects can also be formed as earth mounds or earth berms or ‘green roofs’ or small hill-like objects or walls or fences or wind-breaks or reinforced concrete structures or mass concrete structures or other structures designed for other purposes such as dams, sea walls, harbour walls, buttress walls, flood protection walls and noise barrier walls etc.

FIG. 17 shows some examples of a family of new roof-mounted or object-mounted wind or fluid flow and energy enhancing enhancing linear members, 1, classed as Bi-directional fluid-flow enhancers attached (together with wind energy converters or turbines or fluid flow energy converters or turbines) to flat roofed building structures, 15, or other flat surfaced objects. The variants illustrated show the fluid-flow enhancing linear member and turbines attached to the mid-region of the roof and aligned to be parallel to one of the walls (a), or the fluid-flow enhancing linear member and turbines may also be attached diagonally across the roof (b) or the fluid-flow enhancing linear member and turbines may also be attached along one or more edges (eaves or verges) (c) of the flat roof and in this arrangement can be configured as parapets. Variant (d) illustrates the fluid-flow enhancing linear members and turbines attached in a cruciform arrangement on to the flat roof or flat object such that the devices can receive winds or fluid flows from a wider range of directions. A further arrangement not shown would involve fluid-flow enhancing linear member and turbines being attached in a diagonal cruciform or ‘X’ form to the flat roof. An additional arrangement not shown involves attaching the fluid-flow enhancing linear members and turbines such that the fluid-flow enhancing linear members form the leg and the arms of a ‘Y’ shape arrangement. The fluid-flow enhancing linear members and turbines can also be attached to other components located on the flat roof such as roof lights for example. Variants (a) to (b) show the fluid-flow enhancing linear members of Bi-directional variants set at zero pitch or tilt angle (e.g. horizontal) but the fluid-flow enhancing linear members of the Mono-directional or Dual-directional variants are tilted to an optimum pitch angle greater that plus or minus one degree from horizontal or an adjustable pitch angle arrangement can be employed. Members supporting the fluid-flow enhancing linear members can be below the planar linear member as in variants (a) to (d) but the support members can extend above Side B of the linear flow enhancing member and the support members can also be separate from the host building or object. The support member can also be shaped with a similar profile shape as that employed on the fluid-flow enhancing linear member. The variants illustrated show the fluid-flow enhancing linear members to be straight and non-tapered but where appropriate these members can also be tapered and/or shaped to follow a curved path. The examples illustrated in FIG. 17 show the fluid-flow enhancing linear members and turbines mounted onto sloped plinth walls but such plinth walls may be omitted or be formed by rounded profile plinth walls. The flat roofs can also be configured as canopy roofs or pergola roofs or gazebo roofs or shelter roofs or loggia roofs.

FIG. 18 shows some cross-sectional profile views of examples of a family of new roof-mounted or object-mounted wind or fluid flow and energy enhancing enhancing linear members (1) classed as Mono-directional enhancers ((g) and (i)), Dual-directional enhancers ((g) and (i)), Bi-directional enhancers ((a) through to (f), plus (h) and (j)) attached (together with wind energy converters or turbines or fluid-flow energy converters or turbines) to flat roofed building structures or other flat surfaced objects such that Side A of the fluid-flow enhancing linear members faces towards the host object or roof surface. The variants (f), (h) and (i) show the planar linear enhancing member attached to the mid region of the roof or host object. The variants (a) through to (e), plus (g) and (j) show the fluid-flow enhancing linear members and turbines attached along one or more edges (e.g. eaves or verges) (c) of the flat roof. The variants (b), (e) and (j) show the fluid-flow enhancing linear members and turbines attached along one or more edges (eaves or verges) (c) of the flat roof raised above the flat roof surface in the manner of ‘parapets’ on rounded profile plinth walls (b) or on sloping plinth walls or edge walls (j). Variant (f) shows the fluid-flow enhancing linear member and turbine raised above the mid-region of the flat roof surface on a dual slope plinth wall. Variants ((b) through to (f), plus (h) and (j)) show the fluid-flow enhancing linear members of the Bi-directional variants set at zero pitch or tilt angle (e.g. horizontal in the examples shown) but they can be set at a tilted pitch angle of more than plus or minus one degree as in variant (a). The fluid-flow enhancing linear members of the Mono-directional or Dual-directional variants such as (g) and (i) are shown tilted to an optimum pitch angle greater than plus or minus one degree from horizontal. An adjustable pitch angle arrangement can be employed on all variants if appropriate. Flat roofs or other flat objects may have the profile of the edge or eaves rounded ((a) and (c)) to improve wind flow or fluid flow and a similar advantage may be achieved if the walls of the flat roof building or host object are sloping (i) or sloping and rounded as in (g). The flat roofs can also be configured as canopy roofs or pergola roofs or gazebo roofs or shelter roofs or loggia roofs.

FIG. 19 shows examples of a family of new corner-mounted or side-mounted or end-mounted fluid-flow enhancing linear members classed as building-mounted or structure-mounted Bi-directional wind or fluid flow and energy enhancers in which the building-mounted or structure-mounted fluid-flow enhancing linear members are configured such that the longitudinal axis of the fluid-flow enhancing linear members are aligned to be parallel to the longitudinal axis of the host building or structure. Variant (a) shows an example of corner-mounted fluid-flow enhancing linear members with wind energy converters or wind turbines or fluid flow energy converters or turbines, 2, positioned adjacent to Side A and between the fluid-flow enhancing linear members (1) and the corners of the host building or structure, 16. It would also be possible for variant (a) to be configured with side-mounted fluid-flow enhancing linear members and turbines (similar the arrangement shown in variant (c)) with fluid-flow enhancing linear members oriented vertically or diagonally across one or more sides of the host building or host structure, 16. Variant (a) shows a four-sided building, 16, but other options can include structures with three sides or five or more sides. Variant (b) shows an example of side-mounted fluid-flow enhancing linear members and turbines attached to the sides of a circular plan cylindrically shaped building or structure, 17, though other variants could have plan shapes of an elliptical profile or other curved profile such as pear profile, egg profile, heart profile, crescent profile, segment profile or kidney profile or a combination of these. Variant (b) shows the side-mounted fluid-flow enhancing linear members and turbines to be vertically aligned but they could also be configured to follow an inclined helical path around the host building or host object. Variant (c) shows an example of side-mounted and end-mounted fluid-flow enhancing linear members and turbines attached to the sides and ends of a building or structure, 18, with a ‘flat-oval’ shaped plan (consisting of largely flat sides and rounded ends). Other options include more tapered building or structure shapes or twisted shapes or more ‘sculpted’ forms of building shape to which are attached corner-mounted or side-mounted or end mounted or helically-mounted fluid-flow enhancing linear members and turbines. The fluid-flow enhancing linear members shown are Bi-directional variants but it is also possible to utilise Mono-directional or Dual-directional variants in these configurations. The turbines, 2, shown are cross-flow turbines but axial-flow or mixed-flow turbines may also be utilised.

FIG. 19 (a) shows examples of a family of devices comprising a wind or fluid flow and energy enhancer comprising an linear member consisting of one convex surface and one flat surface positioned adjacent to a corner of a building with wind energy converters or wind turbines or fluid flow energy converters or fluid flow turbines positioned between Side A of the fluid-flow enhancing linear member and the corner of the building.

FIG. 20 shows various examples of a family of new roof-mounted or top-mounted fluid-flow enhancing linear members classed as building-mounted or structure-mounted Bi-directional wind or fluid flow and energy enhancers in which the top-mounted fluid-flow enhancing linear members are configured in a bi-planar arrangement which projects upwards from the top of the host building or host object in the form of a two pronged fork or in the form of the letter ‘U’ such that wind energy converters or wind turbines or fluid energy converters or fluid-flow turbines are positioned between the two ‘prongs of the fork’. The longitudinal axis or y-Axis of the fluid-flow enhancing linear members is aligned to be parallel or at a small angle to the longitudinal-axis of the host building or structure if the host building or structure is a tall or high-rise building or structure. The longitudinal axis or y-Axis of the fluid-flow enhancing linear members is aligned to be vertical and at an angle of 90 degrees to the longitudinal axis of the host building or structure if the host building or structure is a rectangular low-rise building or structure. Variants (a) and (c) show ‘open-top’ ‘U-shaped’ arrangements mounted on the top of a tall structure or building. Variant (c) shows a ‘stack’ or ‘column’ of one or more propeller type axial-flow turbines positioned between the vertical or near vertical fluid-flow enhancing linear members of the bi-planar Bi-directional fluid flow enhancer. Vertical axis traverse-flow turbines or horizontal axis traverse-flow turbines can also be utilised in this variant. Variant (a) is similar to that shown in variant (c) except that the turbines are arranged in rows within horizontally aligned bi-planar Bi-directional fluid-flow enhancers consisting of two fluid-flow enhancing linear members. Variant (a) shows three rows of horizontal bi-planar enhancers and wind turbines or fluid flow turbines. Variants (b) and (d) show ‘closed-top’ top-mounted fluid flow enhancers which consist of a vertical bi-planar fluid-flow enhancer capped with a horizontally aligned fluid-flow enhancing linear member. These fluid-flow enhancing linear members enclose a rectangular zone in which wind energy converters or wind turbines or fluid energy converters or fluid-flow turbines are positioned. Variants (b) and (d) show two or more vertical axis traverse-flow turbines but axial flow turbines or horizontal axis cross flow turbines may also be utilised. The upward pointing fluid-flow enhancing linear members are shown vertically aligned but they can be inclined so as to be converging or diverging relative to each other. Bi-planar Bi-directional fluid flow enhancers are shown, but Mono-directional or Dual-directional variants can also be employed and if appropriate these could be arranged to ‘yaw’ about a vertical axis parallel to the longitudinal axis of the host building or structure if it is tall or high rise. These top mounted configurations could also applied to low rise buildings especially those with flat roofs and if appropriate these configurations could also be arranged to ‘yaw’ about a vertical axis 90 degrees to the longitudinal axis of the host building.

FIGS. 2 (a), 2 (b), 2 (c), 2 (d), 2 (e) 2 (f), 2 (g), 2 (h), 2 (i), 2 (k), 4 (a), 4 (b), 4 (c), 4 (d), 4 (e), 4 (f), 4 )j) and 4 (k) show some examples of cross sectional profiles of new mono-planar wind enhancers or wind or fluid flow and energy enhancers arranged such that the fluid-flow enhancing linear members could be configured as horizontally aligned elevated buildings or structures supported on stilts or support walls in the manner of a bridge-like structure in which residential or non-domestic accommodation is provided inside the fluid-flow enhancing linear member. Can be configured as a link-bridge between adjacent buildings or structures. Can be classed as Bi-directional enhancers, Mono-directional enhancers or Dual-directional enhancers according to profile shape and tilt angle. If applied in the orientation illustrated in the Figures the top (Side B) of each of the fluid-flow enhancers would also be the upper surface in the bridge-like structure and the turbines would be positioned below Side A of the fluid-flow enhancing linear member. As well as being applied in the orientation illustrated in the Figures, the wind or fluid-flow enhancers could be applied as a bridge-like structure in inverted form so that turbines would then be positioned above Side A of the fluid-flow enhancing linear member and Side A would be above Side B of the fluid-flow enhancing linear member.

FIGS. 6 (a), 6 (b), 6 (c), 6 (d), 6 (e) 6 (f), 6 (g), 6 (h), 6 (m) and 6 (n) shows some examples of cross sectional profiles of new bi-planar wind or fluid flow and energy enhancers arranged such that the fluid-flow enhancing linear members could be configured as horizontally aligned elevated buildings or structures supported on stilts or support walls in the manner of a bridge-like structure in which residential or non-domestic accommodation is provided inside one or both of the fluid-flow enhancing linear members. Can be configured as a link bridge between adjacent buildings or structures. Can be classed as Bi-directional enhancers, Mono-directional enhancers or Dual-directional enhancers according to profile shape and tilt angle.

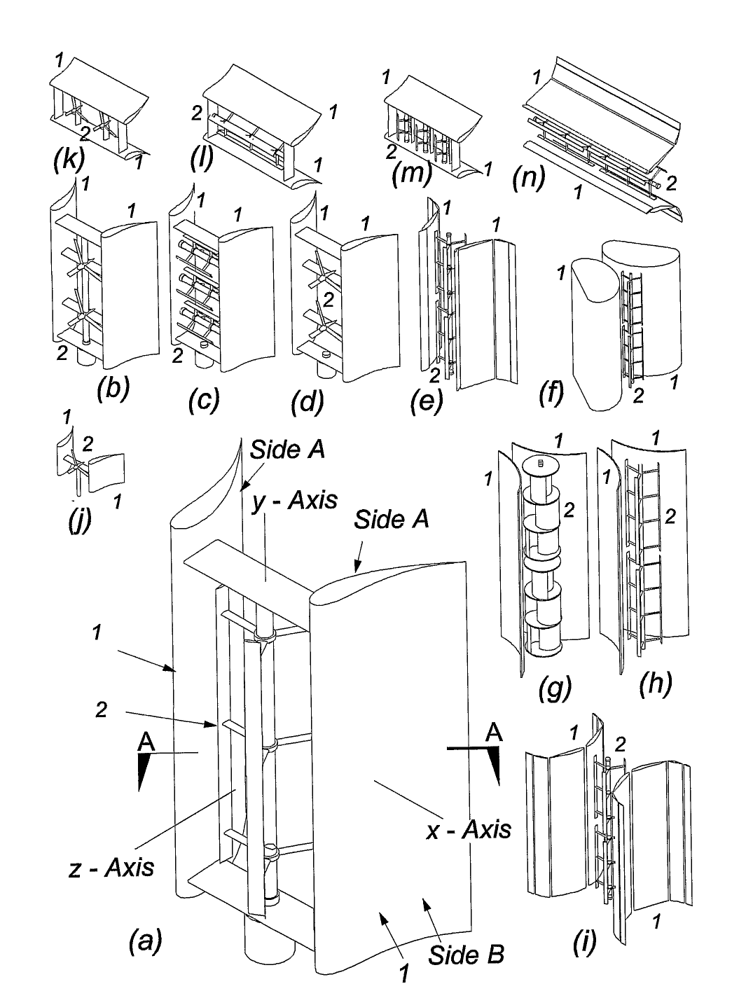

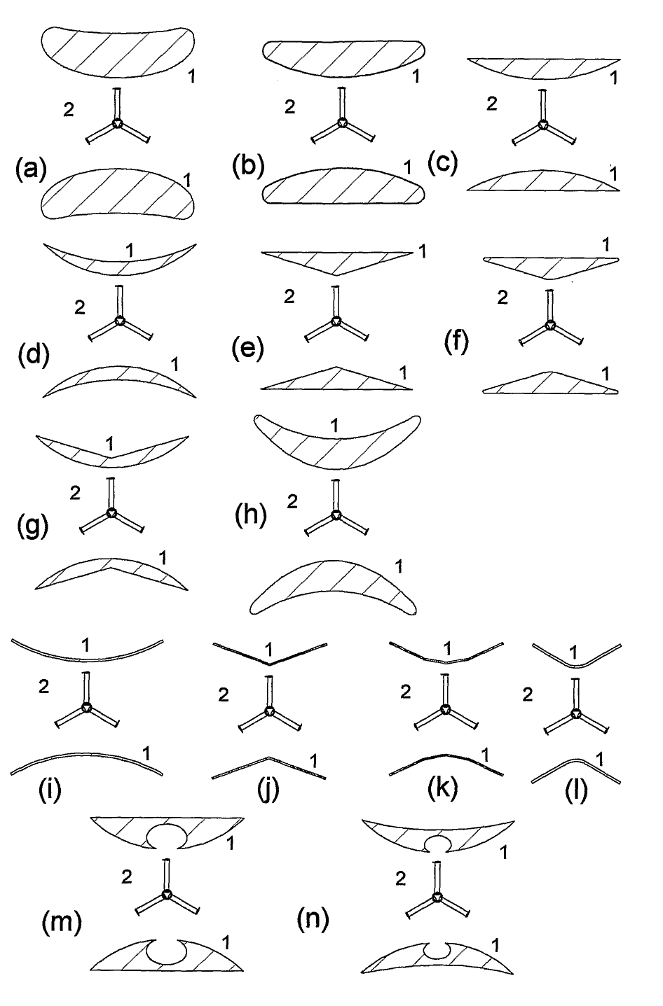

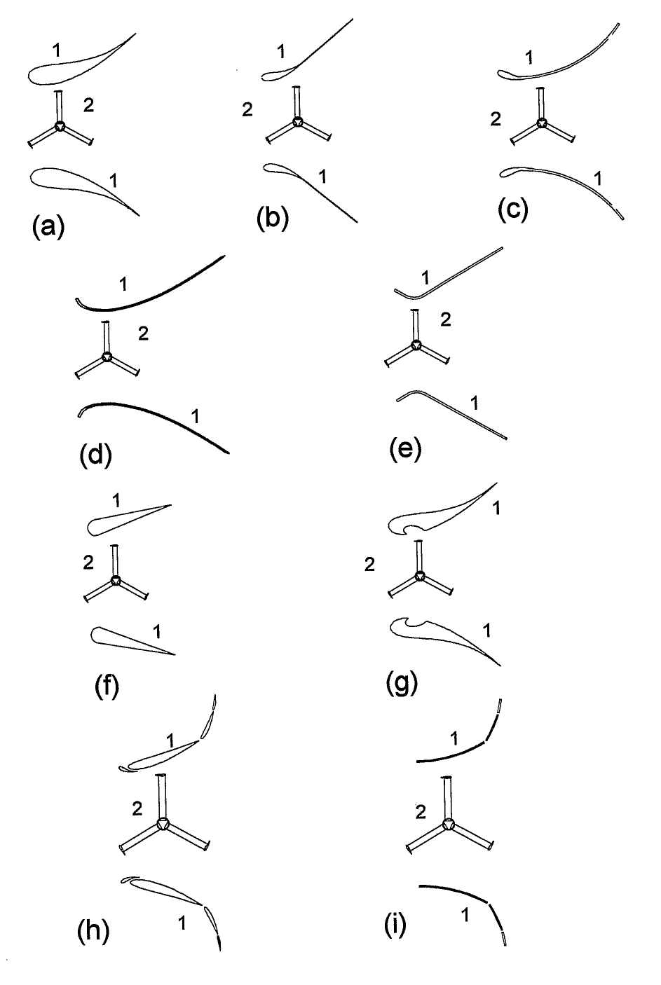

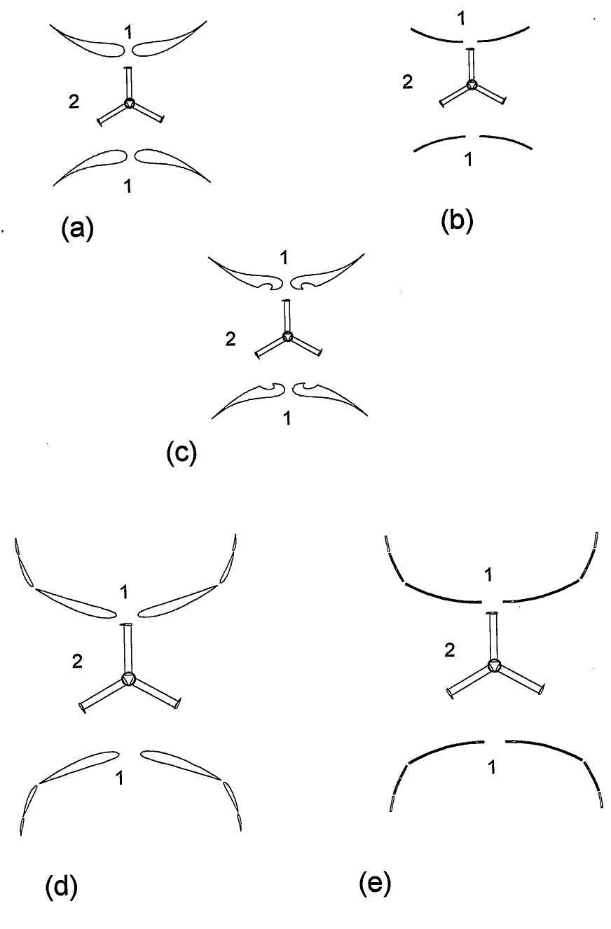

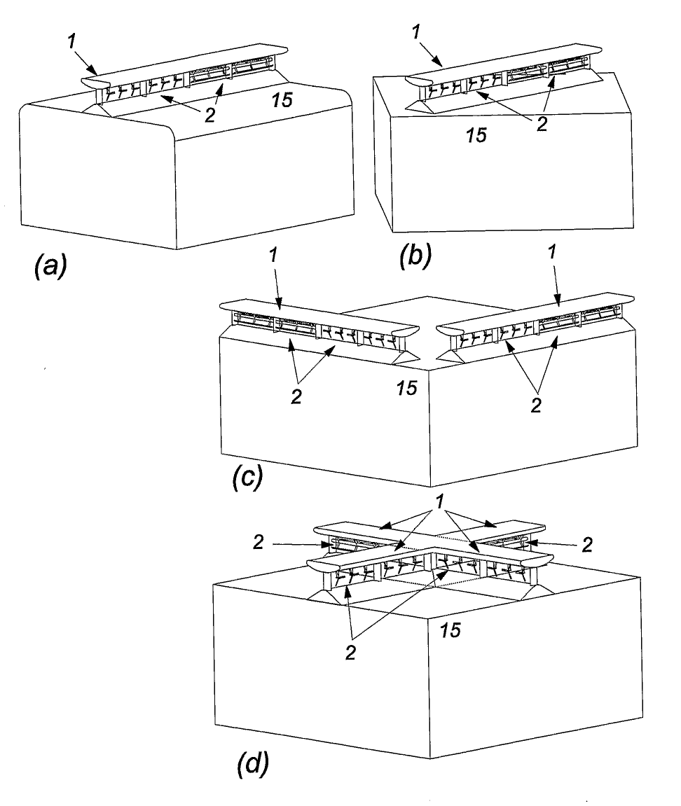

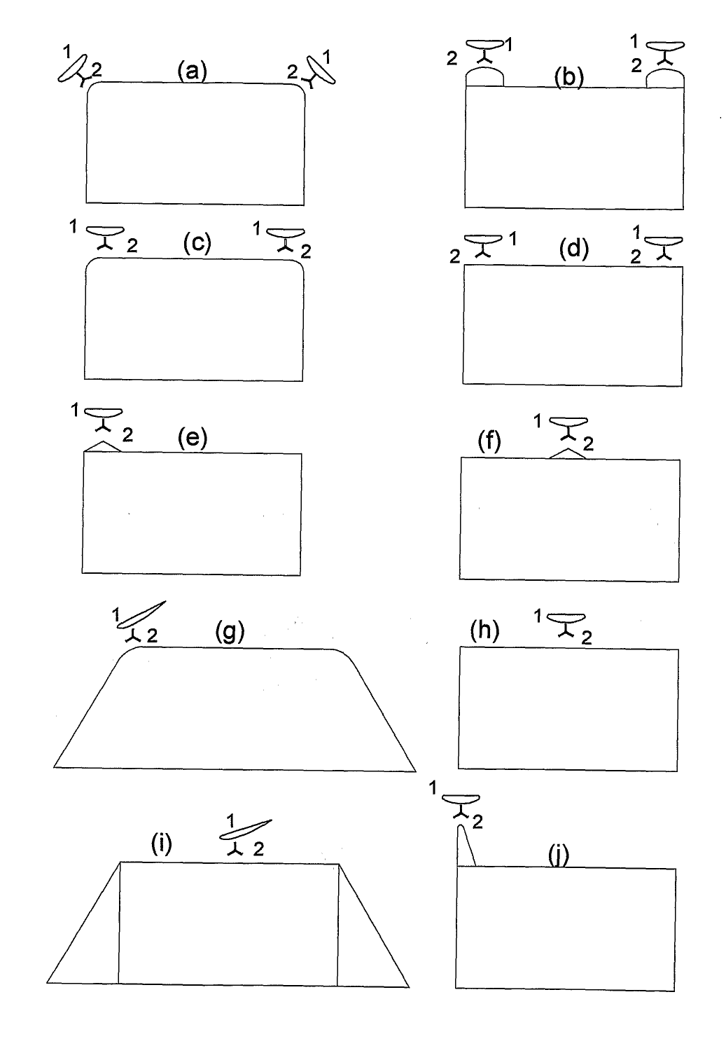

FIGS. 6 (a), 6 (b), 6 (c), 6 (d), 6 (e) 6 (f), 6 (g), 6 (h), 6 (m) and 6 (n): A further range of variants of dual sized bi-planar wind or fluid flow and energy enhancers similar to the variants (a) through to (h) plus (m) and (n) illustrated in FIG. 6 can be achieved by the first fluid-flow enhancing linear member having physical dimensions larger than the second fluid-flow enhancing linear member. The second fluid-flow enhancing linear member could be the same cross sectional profile shape yet physically smaller or the second fluid-flow enhancing linear member could have s different profile such as one of the fluid-flow enhancing linear members shown in FIG. 2 or FIG. 3, or FIG. 4 or in FIG. 9. The wind energy converters or turbines or fluid-flow energy converters or turbines are located between Side A of the first fluid-flow enhancing linear member and Side A of the second fluid-flow enhancing linear member. These dual sized bi-planar wind enhancers or fluid-flow enhancers can be classed as Bi-directional enhancers, Mono-directional enhancers or Dual-directional enhancers according to profile shapes and tilt angles. Dual sized bi-planar fluid-flow enhancers can be applied to horizontally aligned elevated buildings or structures supported on stilts or support walls in the manner of a bridge-like structure in which residential or non-domestic accommodation is provided inside the first fluid-flow enhancing linear member. This dual sized bi-planar bridge-like structure arrangement can be configured such that the first fluid-flow enhancing linear member is positioned below the second fluid-flow enhancing linear member and the turbines are located above the first fluid-flow enhancing linear member and below the second fluid-flow enhancing linear member. The dual sized bi-planar bridge-like structure arrangement could also be configured such that the first fluid-flow enhancing linear member is positioned above the second fluid-flow enhancing linear member and the turbines are located above the second fluid-flow enhancing linear member and below the first fluid-flow enhancing linear member. Can be configured as a link bridge between adjacent buildings or structures.

FIGS. 2 (a), 2 (b), 2 (c), 2 (d), 2 (e) 2 (f), 2 (g), 2 (h), 2 (i), 2 (k), 4 (a), 4 (b), 4 (c), 4 (d), 4 (e), 4 (f), 4 (j) and 4 (k) shows some examples of cross sectional profiles of new mono-planar wind or fluid flow and energy enhancers arranged such that the fluid-flow enhancing linear members could be configured as horizontally aligned bridge structures in which pedestrian traffic or vehicular traffic or rail traffic or levitated/track traffic is able to pass inside the fluid-flow enhancing linear member. Can be classed as Bi-directional enhancers, Mono-directional enhancers or Dual-directional enhancers according to profile shape and tilt angle. If applied in the orientation illustrated in the Figures the top (Side B of the fluid-flow enhancing linear member) of each of the fluid-flow enhancers would also be the upper surface in the bridge structure and the turbines would be positioned below Side A of the fluid-flow enhancing linear member. As well as being applied in the orientation illustrated in the Figures, the wind or fluid-flow enhancers could be applied as a bridge structure in inverted form so that turbines would then be positioned above Side A of the fluid-flow enhancing linear member and Side A would be above Side B of the fluid-flow enhancing linear member.

FIGS. 6 (a), 6 (b), 6 (c), 6 (d), 6 (e) 6 (f), 6 (g), 6 (h), 6 (m) and 6 (n) shows some examples of cross sectional profiles of new bi-planar wind or fluid flow and energy enhancers arranged such that the fluid-flow enhancing linear members could be configured as horizontally aligned bridge structures in which pedestrian traffic or vehicular traffic or rail traffic or levitated/track traffic is able to pass inside one or both of the fluid-flow enhancing linear members. Can be classed as Bi-directional enhancers, Mono-directional enhancers or Dual-directional enhancers according to profile shape and tilt angle.

FIGS. 6 (a), 6 (b), 6 (c), 6 (d), 6 (e) 6 (f), 6 (g), 6 (h), 6 (m) and 6 (n): A further range of variants of dual sized bi-planar wind or fluid flow and energy enhancers similar to the variants (a) through to (h) plus (m) and (n) illustrated in FIG. 6 can be achieved by the first fluid-flow e hancing linear member having physical dimensions larger than the second fluid-flow enhancing linear member. The second wind or fluid-flow enhancing linear member could be the same cross sectional profile shape yet physically smaller or the second fluid-flow enhancing linear member could have s different profile such as one of the fluid-flow enhancing linear members shown in FIG. 2 or FIG. 3, or FIG. 4 or in FIG. 9. The wind energy converters or turbines or fluid-flow energy converters or turbines are located between Side A of the first fluid-flow enhancing linear member and Side A of the second fluid-flow enhancing linear member. These dual sized bi-planar wind enhancers or fluid-flow enhancers can be classed as Bi-directional enhancers, Mono-directional enhancers or Dual-directional enhancers according to profile shapes and tilt angles. Dual sized bi-planar fluid-flow enhancers can be applied to horizontally aligned bridge structures in which pedestrian traffic or vehicular traffic or rail traffic or levitated/track traffic is able to pass inside the first fluid-flow enhancing linear member. This dual sized bi-planar bridge structure arrangement can be configured such that the first fluid-flow enhancing linear member is positioned below the second fluid-flow enhancing linear member and the turbines are located above the first fluid-flow enhancing linear member and below the second fluid-flow enhancing linear member. The dual sized bi-planar bridge structure arrangement could also be configured such that the first fluid-flow enhancing linear member is positioned above the second fluid-flow enhancing linear member and the turbines are located above the second fluid-flow enhancing linear member and below the first fluid-flow enhancing linear member. Can be configured as a link bridge between adjacent buildings or structures.

FIGS. 2 (a), 2 (b), 2 (c), 2 (d), 2 (e) 2 (f), 2 (g), 2 (h), 2 (i), 2 (k), 4 (a), 4 (b), 4 (c), 4 (d), 4 (e), 4 (f), 4 (j) and 4 (k) shows some examples of cross sectional profiles of new mono-planar wind or fluid flow and energy enhancers arranged such that the fluid-flow enhancing linear members could be configured as horizontally aligned bridge structures in which pedestrian traffic or vehicular traffic or rail traffic or levitated/track traffic is able to pass inside one of the linear members and this member has a physical dimension larger than the second linear member and a physical dimension larger than the third linear member if a third linear member is employed. Can be classed as Mono-directional enhancers, Dual-directional enhancers, Bi-directional enhancers, Multi-directional enhancers, multiple element enhancers, slotted enhancers.

FIGS. 13 (n), 13 (o), 13 (p), 13 (q), 13 (r), 13 (s), 13 (t), 13 (u) and 13 (v) shows some examples of cross sectional profiles of new multi-planar wind or fluid flow and energy enhancers arranged such that the fluid-flow enhancing linear members could be configured as horizontally aligned bridge structures in which pedestrian traffic or vehicular traffic or rail traffic or levitated/track traffic is able to pass inside one or more of the fluid-flow enhancing linear members. Examples shown can be classed as Bi-directional enhancers but they could be classed as Mono-directional enhancers or Dual-directional enhancers according to profile shape and tilt angle of outer planes.

### TECHNICAL FEATURES—DESCRIPTION

In the above figures one or more linear members 1, define improved and enhanced linear surfaces which may be movable relative to each other, and relative to a wind energy converter or fluid energy converter (e.g. cross-flow turbine or axial flow turbine or mixed flow turbine or other fluid energy converter) 2 which is located adjacent to one of the linear surfaces or between the linear surfaces.

The present invention also has several variants, which can be described as having one or more of the following:—
a) Improved and enhanced Mono-directional device with static wind or fluid-flow and energy enhancer
b) Improved and enhanced Dual-directional device with static wind or fluid flow and energy enhancer
c) Improved and enhanced Bi-directional device with static wind or fluid-flow and energy enhancer
d) Bridge or bridge-like variants of the improved and enhanced device with static wind or fluid-flow and energy enhancers
e) Improved and enhanced Multi-stage Modular Bi-directional device with each stage consisting of static wind or fluid-flow and energy enhancer of ‘bi-directional’ ‘planes’ consisting of two improved planes or two multiple element planes
f) Improved and enhanced Multi-directional device with static wind or fluid flow and energy enhancer of ‘bi-directional’ ‘planes’ or fairings
g) Improved and enhanced device with standalone wind or fluid flow and energy enhancer consisting of two improved planes or two multiple element planes yawable about the y-Axis
h) Improved and enhanced device with standalone wind or fluid flow and energy enhancer consisting of one improved plane or one multiple element plane yawable about the y-Axis
i) Improved device with standalone wind or fluid flow and energy enhancer consisting of two improved planes or two multiple element planes combined with a third plane or third object and yawable about the y-Axis
j) Improved and enhanced device with standalone wind or fluid flow and energy enhancer consisting of two improved planes or two multiple element planes yawable about the x-Axis
k) Improved and enhanced device with standalone wind or fluid flow and energy enhancer consisting of one improved plane or one multiple element plane yawable about the x-Axis
l) Improved and enhanced device with standalone wind or fluid flow and energy enhancer consisting of two improved planes or two multiple element planes combined with a third plane or third object and yawable about the x-Axis.
m) Improved device with structure integrated static wind or fluid-flow and energy enhancers
n) Improved and enhanced device having structure-integrated movable wind or fluid-flow and energy enhancers
o) Improved and enhanced device having wind or fluid-flow energy enhancer for vehicle propulsion
   a. Improved and Enhanced Mono-Directional Device With Static Wind or Fluid-Flow and Energy Enhancer

This improved and enhanced static wind or fluid-flow enhancer has a fixed orientation and is a Mono-directional device. In terms of this document the definition of Mono-directional refers to the ability of the device to function as an energy enhancing wind energy conversion system or fluid-flow energy conversion system with the wind or fluid flow entering the device from one side but whilst the direction of the Mono-direction may be fixed the capture angle for useable fluid flows or wind directions either side of the z-Axis may be large.

It consists of one or more improved and enhanced wind or fluid-flow and energy enhancing surfaces or planes or multiple element planes 1. The wind stream or fluid stream passing through the improved and enhanced wind or fluid-flow and energy enhancer is accelerated in a more effective manner as a result of improved laminar flow performance and improved flow attachment. One or more wind turbines or fluid turbines or other forms of fluid energy converters, 2, are located at or near the region of highest wind or fluid velocity to extract increased power from the accelerated wind or fluid flow.

When the improved and enhanced wind or fluid-flow and energy enhancer is formed by two multiple element planes, they are arranged so that they each accelerate the fluid flow in the same region combining the wind or fluid-flow and energy enhancing effect of each plane and are usually positioned symmetrically about the y-Axis or about the z/y Plane. The multiple element planes can be of the same size or one multiple element plane can be larger than the other multiple element plane. The multiple element planes can be parallel or diverging in relation to each other relative to the y-Axis or relative to the z/y Plane.

One or more of the improved and enhanced planes or multiple element planes can also be individually or collectively configured in a ‘swept’ configuration such that the planes are aligned with an angle between the y-Axis and the z-Axis. The improved and enhanced planes can also be individually or collectively configured in a ‘dihedral’ configuration or in an ‘anhedral’ configuration with the planes aligned with an angle between the y-Axis and the x-Axis. The improved and enhanced planes can also be individually or collectively configured in a ‘polyhedral’ configuration or in a ‘gull-wing’ configuration or in a ‘curved polyhedral’ configuration either in a concentric or convergent or divergent manner relative to each other about the z-Axis. One or more of the improved and enhanced planes or multiple element planes can also be configured with a built-in ‘twist’ or ‘warp’ about an axis in line with or parallel to the y-Axis between each end of the plane or between either end of the plane and a mid region of the plane. The improved and enhanced planes can be configured so that such ‘twisting’ or ‘warping’ could be adjustable.

Improved and enhanced Mono-directional wind or fluid-flow and energy enhancers may be formed by three multiple element planes and at least one wind turbine or fluid turbine or other form of fluid energy converter is required for power extraction.

If the wind flow or fluid flow is largely horizontal (as is the case with most winds or underwater currents suitable for power production) the improved and enhanced Mono-directional static linear wind or fluid-flow enhancer can be arranged so that the y-Axis is vertical or horizontal or aligned with an angle in between (see FIG. 1 and 5). The z-Axis will generally be horizontal but can be positioned at an angle between horizontal and vertical depending on the fluid flow conditions. When the y-Axis is vertical the improved and enhanced static linear members can be formed by buildings or tower structures with the appropriate floor plan shape and cladding form.

When the y-Axis is vertical the improved and enhanced static linear Improved and enhanced Mono-directional wind or fluid-flow and energy enhancers can be attached to a host building roof and project up from the building roof. Similarly if the y-Axis is horizontal the improved and enhanced static linear Improved and enhanced Mono-directional wind or fluid-flow and energy enhancers can be attached to a host building wall or side and project outwards from the building wall or side.

b. Improved and Enhanced Dual-Directional Device With Static Wind or Fluid Flow and Energy Increasing Enhancer

This static wind or fluid-flow energy enhancer has a fixed orientation and in appearance can be very similar to (a) but it is a Dual-directional device and can accept winds or fluid flows from either side though its effectiveness as an energy enhancing wind or fluid energy conversion system differs according to the side from which the wind or fluid-flow enters the device.

In terms of this document the definition of Dual-directional refers to the ability of the device to function as an energy enhancing wind energy conversion or fluid energy conversion system with the wind or fluid flow entering the device from either side but its effectiveness is not necessarily the same in terms of energy capture. Dual-directional variants of the device include devices that are symmetric about the z-Axis or the z/y Plane of the device but not symmetric about the x-Axis or the x/y Plane. A Dual-directional variant acts as a fluid-flow expander with the fluid-flow flowing from one side of the device relative to the x/y Plane or as a fluid-flow constrictor when the fluid-flow is approaching from the other side of the device relative to the x/y Plane. But whilst the directions of the Dual-directions may be fixed, the capture angle for useable fluid flows or wind directions either side of the z-Axis or the z/y Plane may be large.

It consists of one or more improved and enhanced wind or fluid-flow and energy enhancing surfaces or planes or multiple element planes, 1. The wind stream or fluid stream passing through the wind or fluid-flow and energy enhancer is accelerated in a more effective manner as a result of improved laminar flow performance and improved flow attachment. One or more wind turbines or fluid-flow turbines or other forms of fluid energy converters, 2, are located at or near the region of highest wind or fluid velocity to extract power from the accelerated wind or fluid-flow.

One or more of the improved and enhanced planes or multiple element planes can also be individually or collectively configured in a ‘swept’ configuration such that the planes are aligned with an angle between the y-Axis and the z-Axis. The improved and enhanced planes can also be individually or collectively configured in a ‘dihedral’ configuration or in an ‘anhedral’ arrangement with the planes aligned with an angle between the y-Axis and the x-Axis. The improved and enhanced planes can also be individually or collectively configured in a ‘polyhedral’ configuration or in an ‘gull-wing’ configuration or in a ‘curved polyhedral’ configuration either in a concentric or convergent or divergent manner relative to each other about the z-Axis. One or more of the improved and enhanced planes or multiple element planes can also be configured with a built-in ‘twist’ or ‘warp’ about an axis in line with or parallel to the y-Axis between each end of the plane or between either end of the plane and a mid region of the plane. The improved and enhanced planes can be configured so that such ‘twisting’ or ‘warping’ could be adjustable.

When the improved and enhanced wind or fluid-flow enhancer is formed by two multiple element planes, they are arranged so that they each accelerate the fluid flow in the same region combining the wind or fluid-flow and energy enhancing effect of each plane and are usually positioned symmetrically about the z-Axis or about the z/y Plane. The multiple element planes can be of the same size or one multiple element plane can be larger than the other multiple element plane. The multiple element planes can be parallel or diverging in relation to each other relative to the y-Axis or relative to the z/y Plane.

Improved Dual-directional wind or fluid-flow and energy enhancers may be formed by three or more multiple element planes and at least one wind turbine or fluid-flow turbine or other form of fluid energy converter, 2, is required for power extraction.

If the wind flow or fluid flow is largely horizontal (as is the case with most winds or underwater currents suitable for power production) the improved and enhanced Dual-directional static linear wind or fluid-flow and energy enhancer can be arranged so that the y-Axis is vertical or horizontal or at an angle in between (see FIG. 1 or 5). The z-Axis will generally be horizontal but can be positioned at an angle between horizontal and vertical depending on the wind flow or fluid flow conditions. When the y-Axis is vertical the improved and enhanced static linear members can be formed by buildings or tower structures with the appropriate floor plan shape and cladding form.

When the y-Axis is vertical the improved and enhanced static linear Improved and enhanced Dual-directional wind or fluid-flow and energy enhancers can be attached to a host building roof and project up from the building roof. Similarly if the y-Axis is horizontal the improved and enhanced static linear improved and enhanced Dual-directional wind or fluid-flow and energy enhancers can be attached to a host building wall or side and project outwards from the building wall or side.

c. Improved and Enhanced Bi-Directional Device With Static Wind or Fluid-Flow and Energy Enhancer of ‘Bi-Directional’ ‘Planes’

This static improved and enhanced Bi-directional wind or fluid-flow and energy enhancer has a fixed orientation but can accept winds or fluid-flows from either side and its effectiveness as an energy enhancing wind energy or fluid energy conversion system is the same regardless of which side the fluid-flow enters the device.

In terms of this document, the definition of Bi-directional refers to the ability of the device to function as an energy enhanced wind energy or fluid energy conversion system with the wind or fluid-flow entering the device from either side and its effectiveness is essentially the same in terms of energy capture. Bi-directional variants of the device include devices that are symmetric about the z-Axis or z/y Plane of the device but also includes devices that are additionally symmetric about the x-Axis or x/y Plane.

It consists of one or more improved and enhanced ‘bidirectional’ wing-like surfaces or improved and enhanced planes, 1. The wind or fluid stream passing through the wind or fluid-flow and energy enhancer is accelerated in a more effective manner as a result of improved laminar flow performance and improved flow attachment. One or more wind turbines or fluid turbines or other forms of fluid energy converters, 2, are located at or near the region of highest wind or fluid velocity to extract power and energy from the accelerated wind or fluid-flow.

One or more of the improved and enhanced planes or multiple element planes can also be individually or collectively configured in a ‘swept’ configuration such that the planes are aligned with an angle between the y-Axis and the z-Axis. The improved and enhanced planes can also be individually or collectively configured in a ‘dihedral’ configuration or in an ‘anhedral’ arrangement with the planes aligned with an angle between the y-Axis and the x-Axis. The improved and enhanced planes can also be individually or collectively configured in a ‘polyhedral’ configuration or in a ‘gull-wing’ configuration or in a ‘curved polyhedral’ configuration either in a concentric or convergent or divergent manner relative to each other about the z-Axis. One or more of the improved and enhanced planes or multiple element planes can also be configured with a built-in ‘twist’ or ‘warp’ about an axis in line with or parallel to the y-Axis between each end of the plane or between one or either end of the plane and a mid region of the plane. The improved and enhanced planes can be configured so that such ‘twisting’ or ‘warping’ could be adjustable.

When the wind or fluid-flow and energy enhancer is formed by two multiple element bi-directional improved and enhanced planes, they are arranged so that they each accelerate the wind or fluid flow in the same region combining the wind or fluid-flow and energy enhancing effect of each plane and are usually positioned symmetrically about the z-Axis or z/y Plane and additionally symmetrical about the x-Axis or x/y Plane. The multiple element planes can be of the same size or one multiple element plane can be larger than the other multiple element plane. The multiple element planes can be parallel or diverging in relation to each other relative to the y-Axis or relative to the z/y Plane.

Improved wind or fluid-flow enhancers may be formed by three multiple element planes except that at least one wind turbine or fluid-flow turbine or other form of fluid energy converter (2) is required for power extraction.

If the wind flow or fluid-flow is largely horizontal (as is the case with most winds or underwater currents suitable for power production) the static linear wind or fluid-flow and energy enhancer can be arranged so that the y-Axis is vertical or horizontal or an angle in between (see FIG. 1 or 5). The z-Axis will generally be horizontal but can be positioned at an angle between horizontal and vertical depending on the wind or fluid flow conditions. When the y-Axis is vertical the bi-directional improved static linear members can be formed by buildings or tower structures with the appropriate floor plan shape and cladding form.

When the y-Axis is vertical the improved and enhanced static linear improved and enhanced Bi-directional wind or fluid-flow and energy enhancers can be attached to a host building roof and project up from the building roof. Similarly if the y-Axis is horizontal the improved and enhanced static linear improved and enhanced Bi-directional wind or fluid-flow and energy enhancers can be attached to a host building wall or side and project outwards from the building wall or side.

d. Bridge or Bridge-Like Variants of the Improved and Enhanced Device With Static Wind or Fluid-Flow and Energy Enhancers

These improved and enhanced linear wind or fluid-flow and energy enhancers are essentially specific variants of the Mono-directional (a), Dual-directional (b) or Bi-directional variants previously described in (a), (b) and (c) above that are configured as bridges or bridge-like structures with the y-Axis horizontal or near-horizontal such that pedestrian or vehicular traffic or rail traffic is able to move through the interior of one or more of the improved and enhanced planes. Such a bridge or bridge-like structure can configured as a link bridge between two or more buildings or structures or can be configured as bridge used to span over an opening or between two or more points.

One or more wind turbines or fluid-flow turbines or other forms of fluid energy converters, 2, are located at or near the region of highest wind or fluid velocity between one or more of the improved and enhanced planes or multiple element planes to extract power from the accelerated wind or fluid-flow.

e. Improved and Enhanced Multistage Modular Bi-Directional Device With Each Stage Consisting of Static Wind or Fluid-Flow and Energy Enhancer of ‘Bi-Directional’ ‘Planes’ Consisting of Two Improved Planes or Two Multiple Element Planes

Each stage of this static improved and enhanced Bi-directional multi-stage modular wind or fluid-flow and energy enhancer has a fixed orientation but can accept winds or fluid-flows from two sides and its effectiveness as an energy enhancing wind energy or fluid energy conversion system is the same regardless of which side the fluid-flow enters the device.

Each stage of this multi-stage modular variant consists of two improved and enhanced ‘bi-directional’ wing-like surfaces or improved and enhanced planes, 1, configured with a ‘base plate’ and ‘cap plate’ that with the two improved and enhanced planes forms a module that fits within a volume that takes the form of a cube, cuboid or rectangular prism. One module is stacked one above the other and/or side by side to each other and each module is fixed to the other adjacent module by bolting or other secure fastening mechanism or mechanisms. See FIG. 14 for some examples of this columnar modular arrangement, which also shows a helically shaped arrangement of this variant. FIG. 20 (b) and 20 (d) also shows relatively large square and rectangular shaped modules with linear surface wind or fluid-flow and energy enhancers around two sides and at the top and bottom of the device—the examples shown are positioned on the top of a building or other object.

One arrangement with the y-Axis aligned vertically is to stack one module above the other in a columnar arrangement and each module stage can be oriented to be aligned with stage below to receive winds or fluid flow from the same compass or azimuth directions. It would also be possible to position and fasten one or more ‘columns’ side by side and linked together in the manner of a ‘wall’.

Alternatively each stage of a modular column arrangement can be oriented such that it is rotated by 90 degrees about its y-Axis relative to the stage below to permit the device to receive winds or fluid flows from two additional principal azimuth or compass directions.

Another example of a columnar arrangement with the y-Axis aligned vertically is a three-stage arrangement based on a module which has a ‘base plate’ and ‘cap plate’ shaped in the form of a disc shape. This shape of ‘base plate’ and ‘cap plate’ allows each stage to be rotated about its y-Axis relative to the stage below and oriented with 120 degrees offset. This arrangement permits a three stage modular device to receive winds or fluid flows from six principal compass or azimuth directions. This disc plate interface arrangement permits a range of other degrees of azimuth offset relative to the module below if appropriate.

A ‘wall-like’ horizontally aligned arrangement with the y-Axis aligned horizontally—and the ‘base plate’ and ‘cap plate’ configured as square shaped or rectangular shaped end plates—and each module fastened to each other side by side in a row in the form of a wall and which could be used to form of a parapet wall on a roof top. It would be possible to construct taller ‘walls’ by positioning and fastening one such row of modules above another row of modules or in the manner of bricks in a brick wall.

At each stage one or more wind turbines or fluid turbines or other forms of fluid energy converters, 2, are located at or near the region of highest wind or fluid velocity to extract power and energy from the accelerated wind or fluid-flow.

f. Improved and Enhanced Multi-Directional Device With Static Wind or Fluid Flow and Energy Enhancer of ‘Bi-Directional’ ‘Planes’ or Fairings

This static improved and enhanced Multi-directional wind or fluid-flow and energy enhancer has a fixed orientation but can accept winds or fluid-flows from a range of azimuth or compass directions with some variants able to accept winds or fluid-flows from 360 degree azimuth or compass directions. Its effectiveness as a wind energy or fluid energy conversion system is consistent regardless of the azimuth direction from which the fluid flow enters the device. It consists of three or more ‘Bi-directional’ wing-like surfaces or improved planes 1 (See FIG. 14). The Multi-directional wind or fluid-flow and energy enhancers may be symmetric about the z-Axis and z/y Plane of the device but not symmetric about the x-Axis. The wind or fluid stream passing through the enhancer is accelerated in a more effective manner as a result of improved laminar flow performance and flow attachment and with the additional feature of Multi-directionality. One or more wind turbines or fluid turbines or other forms of fluid energy converters, 2, are located at or near the region of highest wind or fluid velocity to extract power from the accelerated wind or fluid flow.

When the improved and enhanced Multi-directional wind or fluid-flow and energy enhancer is formed by three Bi-directional planes or three Bi-directional multiple element improved planes, they are arranged so that they each accelerate the wind or fluid flow in the same region and may be positioned symmetrically about the z-Axis but asymmetrically about the x-Axis and arranged such that the chord reference line between the leading edge and trailing edge of each of the three planes or multiple element bidirectional planes forms one side of a triangle as shown in FIG. 14. The multiple element planes can be of the same size or one multiple element plane can be larger than the other multiple element planes. The multiple element planes can be parallel or diverging in relation to each other relative to the y-Axis. One or more wind turbines or fluid turbines or other forms of fluid energy converters, 2, are located at or near the region of highest fluid velocity to extract power from the accelerated wind or fluid-flow. The Bi-directional improved static linear members can be formed by buildings or tower structures with the appropriate floor plan shape and cladding form such as FIG. 14 (c) for example. If the three improved and enhanced planes or multiple element planes are tapered when viewed from Side B they can be inclined towards each other and towards the y-Axis in the manner of a tetrahedral form.

When the improved and enhanced Multi-directional wind or fluid-flow and energy enhancer is formed by four Bi-directional planes (see FIG. 14 (s) for a cross-sectional plan view of one example) or four Bi-directional multiple element improved planes, they are arranged so that they each accelerate the wind flow or fluid-flow in the same region and adjacent regions and may be positioned symmetrically about the z-Axis and is additionally symmetrical about the x-Axis and arranged such that the chord reference line between the leading edge and trailing edge of each of the four planes or multiple element bi-directional planes forms one side of a rectangle. The multiple element planes can be of the same size or one multiple element plane can be larger than the other multiple element planes. The multiple element planes can be parallel or diverging in relation to each other relative to the y-Axis. One or more wind turbines or fluid turbines or other form of fluid energy converter, 2, are located at or near the region of highest fluid velocity to extract power from the accelerated wind or fluid flow. The Bi-directional improved and enhanced static linear wind and fluid flow enhancing members can be formed by buildings or tower structures with the appropriate floor plan shape and cladding form such as FIG. 14 (s) for example. If the four improved and enhanced planes or multiple element planes are tapered when viewed from Side B they can be inclined towards each other and towards the y-Axis in the manner of a pyramidal form.

One or more of the improved and enhanced planes or multiple element planes can also be configured with a built-in ‘twist’ or ‘warp’ about an axis in line with or parallel to the y-Axis between each end of the plane or between either end of the plane and a mid region of the plane. The improved and enhanced planes can be configured so that such ‘twisting’ or ‘warping’ could be adjustable.

g. Improved and Enhanced Device With Standalone Wind or Fluid Flow and Energy Enhancer Consisting of Two Improved Planes or Two Multiple Element Planes Yawable About the y-Axis

Unlike the previous variants this variant of the improved and enhanced linear wind or fluid-flow and energy enhancer is able to adjust the orientation (known as ‘yaw’) of its z-Axis about its y-Axis or about an axis parallel to the y-Axis in response to changes in the azimuth or compass direction of the undisturbed fluid flow or wind or current. It is aligned so that the x-Axis is horizontal and the y-axis is vertical if the fluid flow direction is largely horizontal. One or more wind turbines or fluid turbines or other forms of fluid energy converters are located at or near the region of highest fluid velocity to extract power from the accelerated wind or fluid flow. The planes will generally be parallel to the y-Axis but can diverge or converge relative to the y-Axis or the z/y Plane. The system can be designed so that only the enhancer is yawed or the whole assembly (enhancer and fluid turbine or fluid energy converter) is yawed.

One or more of the improved and enhanced planes or multiple element planes can also be individually or collectively configured in a ‘swept’ configuration such that the planes are aligned with an angle between the y-Axis and the z-Axis. The improved and enhanced planes can also be individually or collectively configured in a ‘dihedral’ configuration or in an ‘anhedral’ arrangement with the planes aligned with an angle between the y-Axis and the x-Axis. The improved and enhanced planes can also be individually or collectively configured in a ‘polyhedral’ configuration or in an ‘gull-wing’ configuration or in a ‘curved polyhedral’ configuration either in a concentric or convergent or divergent manner relative to each other about the z-Axis. One or more of the improved and enhanced planes or multiple element planes can also be configured with a built-in ‘twist’ or ‘warp’ about an axis in line with or parallel to the y-Axis between each end of the plane or between either end of the plane and a mid region of the plane. The improved and enhanced planes can be configured so that such ‘twisting’ or ‘warping’ could be adjustable.

This improved and enhanced linear enhancer may be formed by two improved planes or two multiple element planes in two arrangements. In the first arrangement both the improved planes or multiple element planes may be the same size or different sizes but the profile of the second plane or second multiple element plane is a reflected (about the z/y Plane) or mirror version of the first plane or first multiple element plane, the first plane diverges from the z/y Plane while the second plane diverges from the z/y Plane in the opposite direction. In the second arrangement of this variant the second plane or multiple element plane may have a different cross-sectional shape or profile compared to the first improved plane or first multiple element plane. One or more wind turbines or fluid turbines or other forms of fluid energy converters, 2, are located at or near the region of highest fluid velocity to extract power from the accelerated wind or fluid flow.

h. Improved and Enhanced Device With Standalone Wind or Fluid Flow and Energy Enhancer Consisting of One Improved Plane or One Multiple Element Plane Yawable About the y-Axis

This variant of the improved and enhanced linear wind or fluid-flow and energy enhancer is able to adjust the orientation of its z-Axis about its y-Axis (known as ‘yaw’) or about an axis parallel to the x-Axis in response to changes in the azimuth or compass direction of the undisturbed fluid flow or wind or current. It is aligned such that the y-Axis is vertical and the x-Axis is horizontal if the fluid flow conditions are largely horizontal. The plane will generally be parallel to the y-Axis but can be at an angle to it and can be parallel to the z/y Plane or at an angle to it. In this variant the improved and enhanced plane can also be configured in a ‘swept’ configuration such that the plane is aligned with an angle between the y-Axis and the z-Axis. The improved and enhanced plane can also be configured in a ‘dihedral’ arrangement or in an ‘anhedral’ configuration with the plane aligned with an angle between the y-Axis and the x-Axis. The improved and enhanced plane can also be configured in a ‘polyhedral’ configuration or in an ‘gull-wing’ configuration or in a ‘curved polyhedral’ configuration. One or more of the improved and enhanced planes or multiple element planes can also be configured with a built-in ‘twist’ or ‘warp’ about an axis in line with or parallel to the y-Axis between each end of the plane or between either end of the plane and a mid region of the plane. The improved and enhanced planes can be configured so that such ‘twisting’ or ‘warping’ could be adjustable. In this version the whole assembly (enhancer and fluid turbine) can be yawed. This version can be fitted on to objects such as towers or buildings or building roofs or attached to building walls or to objects such as street light columns where it could also provide power for the lamps.

One or more wind turbines or fluid turbines or other forms of fluid energy converters, 2, are located adjacent to Side A of the linear surface at or near the region of highest wind or fluid velocity to extract power from the accelerated wind or fluid flow (some examples are shown in FIG. 1 (a) through (f) and (h). The system can be designed so that only the enhancer is yawed or the whole assembly (enhancer and fluid turbine or fluid energy converter) is yawed.

In one option for this variant the wind or fluid-flow and energy enhancing linear surface enhancer is able to be a yawable support tower for axial-flow or cross-flow wind turbines such that the whole assembly (enhancer and wind or fluid turbine or fluid energy converter) is yawed.

i. Improved Device With Standalone Wind or Fluid Flow and Energy Enhancer Consisting of Two Improved Planes or Two Multiple Element Planes Combined With a Third Plane or Third Object and Yawable About the y-Axis

Like the previous variant this variant of the improved and enhanced linear wind or fluid-flow and energy enhancer is able to adjust the orientation (known as ‘yaw’) of its z-Axis about its y-Axis or about an axis parallel to the y-Axis in response to changes in the azimuth or compass direction of the undisturbed fluid flow or wind or current. It is aligned so that the x-Axis is horizontal and the y-Axis is vertical if the fluid flow direction is largely horizontal.

The planes will generally be parallel to the y-Axis but can diverge or converge relative to the y-Axis or z/y Plane. One or more wind turbines or fluid turbines or other forms of fluid energy converters, 2, are located at or near the region of highest fluid velocity to extract power from the accelerated wind or fluid flow. The system can be designed so that only the enhancer is yawed or the whole assembly (enhancer and fluid turbine or fluid energy converter) is yawed.

This variant of the improved and enhanced linear wind or fluid-flow and energy enhancer may be formed by two improved and enhanced planes or two multiple element planes combined with a third plane or third linear object which is positioned between the convex surfaces of the first and second improved planes or multiple element planes but can also be positioned such that it is ‘upstream’ or ‘downstream’ of the first two improved planes or multiple element planes relative to the direction of wind or fluid flow (see FIG. 13 (a) through to (h) plus 13 (w) through to (z)). One or more wind turbines or fluid turbines or other forms of fluid energy converters, 2. are located at or near the regions of highest wind or fluid velocity to extract power from the accelerated wind or fluid flow.

One or more of the improved and enhanced planes or multiple element planes can also be individually or collectively configured in a ‘swept’ configuration such that the planes are aligned with an angle between the y-Axis and the z-Axis. The improved and enhanced planes can also be individually or collectively configured in a ‘dihedral’ configuration or in an ‘anhedral’ arrangement with the planes aligned with an angle between the y-Axis and the x-Axis. The improved and enhanced planes can also be individually or collectively configured in a ‘polyhedral’ configuration or in an ‘gull-wing’ configuration or in a ‘curved polyhedral’ configuration either in a concentric or convergent or divergent manner relative to each other about the z-Axis. One or more of the improved and enhanced planes or multiple element planes can also be configured with a built-in ‘twist’ or ‘warp’ about an axis in line with or parallel to the y-Axis between each end of the plane or between either end of the plane and a mid region of the plane. The improved and enhanced planes can be configured so that such ‘twisting’ or ‘warping’ could be adjustable.

The yaw axis of this improved and enhanced linear wind or fluid-flow and energy enhancer, will be at the y-Axis or at an axis parallel to the y-Axis but located within the third plane or within the third linear object.

The third plane or third linear object may be fixed in such a way that the first and second improved and enhanced planes or multiple element planes together with the wind turbines or fluid turbines can yaw around the third plane or third linear object. One or more wind turbines or fluid turbines or other forms of fluid energy converters. 2, are located at or near the regions of wind or fluid velocity to extract power from the accelerated wind or fluid flow. This third linear object can be a building or other structure such as a tower and potentially could have cross-sectional plans similar to the examples shown in FIGS. 13 (w) to 13 (z).

Alternatively all of the improved planes or multiple element planes together with the third plane and the fluid turbines can yaw as one unit about the yaw axis (See cross sectional profile views in FIGS. 13 (a) to 13 (m) of some examples). The first improved plane or first multiple element plane diverges from the z/y Plane, while the second improved plane or second multiple element plane diverges from the z/y Plane in the opposite direction, the third plane or third linear object is symmetrically aligned with the z/y Plane. One or more wind turbines or fluid turbines or other forms of fluid energy converters, 2, are located at or near the region of highest wind or fluid velocity to extract power from the accelerated wind or fluid flow.

In this variant of the improved and enhanced linear wind or fluid-flow and energy enhancer, all the planes and multiple element planes are the same size or of different sizes but the profile of the second improved plane or second multiple element plane is a reflected or mirror version of the first improved plane or first multiple element plane and the third plane is a plane whose shape is symmetrical about the z/y Plane (See examples in FIG. 13).

This variant of the improved and enhance linear wind or fluid-flow and energy enhancer can have sets of wind turbines or fluid flow turbines or fluid energy conversion devices, 2, located between each of the three planes (such as in FIG. 13 (b) for example) or it can have one set of wind turbines or fluid turbines between the first improved plane or first multiple element plane and the second improved plane or second multiple element plane and positioned ‘downstream’ of the third plane or of the third linear object relative to the direction of wind or fluid flow (such as in FIG. 13 (f) for example).

j. Improved and Enhanced Device With Standalone Wind or Fluid Flow and Energy Enhancer Consisting of Two Improved Planes or Two Multiple Element Planes Yawable About the x-Axis

This variant of the improved and enhanced linear wind or fluid-flow and energy enhancer is able to adjust the orientation of its z-Axis about its x-Axis (known as ‘yaw’) or about an axis parallel to the x-Axis in response to changes in the azimuth or compass direction of the undisturbed fluid flow or wind or current. It is aligned such that the y-Axis is horizontal and the x-Axis is vertical if the fluid flow conditions are largely horizontal. The planes will generally be parallel to the y-Axis but can be at an angle to it and can be parallel to the z/y Plane or at an angle to it. In this variant the improved and enhanced planes can also be individually or collectively configured in a ‘swept’ configuration such that the planes are aligned with an angle between the y-Axis and the z-Axis. The improved and enhanced planes can also be individually or collectively configured in a ‘dihedral’ arrangement or in an ‘anhedral’ configuration with the planes aligned with an angle between the y-Axis and the x-Axis. The improved and enhanced planes can also be individually or collectively configured in a ‘polyhedral’ configuration or in an ‘gull-wing’ configuration or in a ‘curved polyhedral’ configuration either in a concentric or convergent or divergent manner relative to each other about the z-Axis. One or more of the improved and enhanced planes or multiple element planes can also be configured with a built-in ‘twist’ or ‘warp’ about an axis in line with or parallel to the y-Axis between each end of the plane or between either end of the plane and a mid region of the plane. The improved and enhanced planes can be configured so that such ‘twisting’ or ‘warping’ could be adjustable. In this version the whole assembly (enhancer and fluid turbine) can be yawed. This version can be fitted on to objects such as towers or buildings or to objects such as street light columns where it could also provide power for the lamps.

This variant of the improved and enhanced linear wind or fluid-flow and energy enhancer may be formed by two improved planes or two multiple element planes in two arrangements. In the first arrangement both the improved planes or multiple element planes may be the same size or different sizes but the profile of the second improved plane or second multiple element plane is a reflected or mirror version of the first plane or first multiple element plane, the first plane diverges from the z/y Plane, while the second plane diverges from the z/y Plane in the opposite direction.

In the second arrangement of this variant the second plane or multiple element plane may have a different cross-sectional shape or profile compared to the first improved plane or first multiple element plane.

k. Improved and Enhanced Device With Standalone Wind or Fluid Flow and Energy Enhancer Consisting of One Improved Plane or One Multiple Element Plane Yawable About the x-Axis

This variant of the improved and enhanced linear wind or fluid-flow and energy enhancer is able to adjust the orientation of its z-Axis about its x-Axis (known as ‘yaw’) or about an axis parallel to the x-Axis in response to changes in the azimuth or compass direction of the undisturbed fluid flow or wind or current. It is aligned such that the y-Axis is horizontal and the x-Axis is vertical if the fluid flow conditions are largely horizontal. The plane will generally be parallel to the y-Axis but can be at an angle to it and can be parallel to the z/y Plane or at an angle to it. In this variant the improved and enhanced plane can also be configured in a ‘swept’ configuration such that the plane is aligned with an angle between the y-Axis and the z-Axis. The improved and enhanced plane can also be configured in a ‘dihedral’ arrangement or in an ‘anhedral’ configuration with the plane aligned with an angle between the y-Axis and the x-Axis. The improved and enhanced plane can also be configured in a ‘polyhedral’ configuration or in an ‘gull-wing’ configuration or in a ‘curved polyhedral’ configuration. One or more of the improved and enhanced planes or multiple element planes can also be configured with a built-in ‘twist’ or ‘warp’ about an axis in line with or parallel to the y-Axis between each end of the plane or between either end of the plane and a mid region of the plane. The improved and enhanced planes can be configured so that such ‘twisting’ or ‘warping’ could be adjustable. In this version the whole assembly (enhancer and fluid turbine) can be yawed. This version can be fitted on to other objects including for example towers or vehicles or buildings or building roofs or be attached to building walls or to objects such as street light columns where it could also provide power for the lamps.

One or more wind turbines or fluid turbines or other forms of fluid energy converters, 2, are located at or near the region of highest wind or fluid velocity to extract power from the accelerated wind or fluid flow either above or below the linear surface. The system can be designed so that only the enhancer is yawed or the whole assembly (enhancer and fluid turbine or fluid energy converter) is yawed.

One arrangement of this variant would involve the linear surface being located above the wind turbine or fluid-flow turbine with Side B uppermost and Side A underneath towards the turbine. Another arrangement of this variant (some examples are shown in FIG. 1 (i), 1 (j) and 1 (k)) involves the linear surface being located below the wind turbine or fluid turbine with Side A uppermost towards the turbine and Side B underneath.

This variant can also be applied to conventional free-standing wind turbines. In this arrangement the wind or fluid-flow and energy enhancing linear surface enhancer can be attached to the support structure for free standing axial flow or cross-flow wind turbines and also be designed so that only the enhancer is able to be yawed or such that the whole assembly (enhancer and wind turbine) is able to be yawed as one entity.

l. Improved and Enhanced Device With Standalone Wind or Fluid Flow and Energy Enhancer Consisting of Two Improved Planes or Two Multiple Element Planes Combined With a Third Plane or Third Object and Yawable About the x-Axis.

Like the previous variant this variant of the improved and enhanced linear wind or fluid-flow and energy enhancer is able to adjust the orientation (known as ‘yaw’) of its z-Axis about its x-Axis or about an axis parallel to the x-Axis in response to changes in the azimuth or compass direction of the undisturbed wind or fluid flow or current. It is aligned such that the y-Axis is horizontal and the x-Axis is vertical if the fluid flow conditions are largely horizontal. The planes will generally be parallel to the y-Axis but can be at an angle to it and can be parallel to the z/y Plane or at an angle to it. In this variant the improved and enhanced planes can also be individually or collectively configured in a ‘swept’ configuration such that the planes are aligned with an angle between the y-Axis and the z-Axis. The improved and enhanced planes can also be individually or collectively configured in a ‘dihedral’ configuration or in an ‘anhedral’ configuration with the planes aligned with an angle between the y-Axis and the x-Axis. The improved and enhanced planes can also be individually or collectively configured in a ‘polyhedral’ configuration or in an ‘gull-wing’ configuration or in a ‘curved polyhedral’ configuration either in a concentric or convergent or divergent manner relative to each other about the z-Axis. One or more of the improved and enhanced planes or multiple element planes can also be configured with a built-in ‘twist’ or ‘warp’ about an axis in line with or parallel to the y-Axis between each end of the plane or between either end of the plane and a mid region of the plane. The improved and enhanced planes can be configured so that such ‘twisting’ or ‘warping’ could be adjustable.

In this version the whole assembly (enhancer and fluid flow turbine) is able to be yawed. One or more wind turbines or fluid turbines or other forms of fluid energy converters, 2, are located at or near the region of highest wind or fluid velocity to extract power from the accelerated wind or fluid flow. This version can be fitted on to objects such as towers or buildings or to objects such as street light columns where it could also provide power for the lamp.

This variant of the improved and enhanced linear wind or fluid-flow and energy enhancer may be formed by two improved and enhanced planes or two multiple element planes combined with a third plane or third linear object which is positioned between the convex surfaces of the first and second improved planes or multiple element planes but can also be positioned such that it is ‘upstream’ or ‘downstream’ of the first two improved planes or multiple element planes. One or more wind turbines or fluid turbines or other form of fluid energy converters are, 2, located at or near the region of highest fluid velocity to extract power from the accelerated wind or fluid flow.

The yaw axis of this improved and enhanced linear wind or fluid-flow and energy enhancer will be at the x-Axis or at an axis parallel to the x-Axis and can be located within the support structure to which it is attached.

All of the improved and enhanced planes or multiple element planes together with the third plane and the wind turbines or fluid turbines can yaw as one unit about the yaw axis. The first improved and enhanced plane or first multiple element plane diverges from the z/y Plane, while the second improved plane or second multiple element plane diverges from the z/y Plane in the opposite direction, the third plane or third linear object is symmetrically aligned with the z/y Plane.

In this variant of the improved and enhanced linear wind or fluid-flow and energy enhancer, all the planes and multiple element planes are the same size or may be of different sizes but the profile of the second improved plane or second multiple element plane is a reflected or mirror version reflected about the z/y Plane of the first improved plane or first multiple element plane and the third plane is a plane whose shape is symmetrical about the z/y Plane.

This variant of the improved wind or fluid-flow and energy enhancer can have sets of wind turbines or fluid flow turbines or fluid energy conversion devices, 2, located between each of the three planes or it can have one set of fluid turbines between the first improved plane or first multiple element plane and the second improved plane or second multiple element plane and positioned ‘downstream’ or ‘upstream’ of the third plane or of the third linear object relative to the direction of wind or fluid flow.

m. Improved Device With Structure Integrated Static Wind or Fluid-Flow and Energy Enhancers

These versions of the improved and enhanced linear wind or fluid-flow and energy enhancers are designed to take advantage of particular characteristics of buildings or structures of appropriate shape that are exposed to winds or other fluid flows. These are described as structure-integrated or building-integrated improved and enhanced linear enhancers. The improved and enhanced planes can also be configured in a ‘swept’ configuration such that the planes are aligned with an angle between the y-Axis and the z-Axis. The improved and enhanced planes can also be configured in a ‘dihedral’ arrangement or in an ‘anhedral’ configuration with the planes aligned with an angle between the y-Axis and the x-Axis. The improved and enhanced planes can also be configured in a ‘polyhedral’ configuration or in an ‘gull-wing’ configuration or in a ‘curved polyhedral’ configuration about the z-Axis. One or more of the improved and enhanced planes or multiple element planes can also be configured with a built-in ‘twist’ or ‘warp’ about an axis in line with or parallel to the y-Axis between each end of the plane or between either end of the plane and a mid region of the plane. The improved and enhanced planes can be configured so that ‘twisting’ or ‘warping’ could be adjustable.

Roof-mounted improved and enhanced mono linear wind or fluid-flow and energy enhancers consisting of Mono-directional or Dual-directional or Bi-directional improved and enhanced planes or multiple element planes are designed to be aligned with and fitted to the ridge-line (or highest part) of dual pitched or mono pitched or mansard or curved or faceted or shell or grid shell or vaulted or hyperboloid or hypar or saddle-shaped or stressed-skin or lamela or geodesic or cable net or textile or membrane type roofs or canopies or pergolas or Dutch barns or loggias or gazebos or walkways or greenhouses or shelters or tents 12 or along the hip line of hipped roofs or multi-sided pointed roofs (see FIG. 15 for some examples of ridge mounted variants). One or more wind turbines or fluid turbines or other forms of fluid energy converters, 2. are located at or near the region of highest wind or fluid velocity to extract power from the accelerated wind or fluid flow between the improved and enhanced mono linear wind or fluid-flow and energy enhancer and the structure to which it is attached.

This version of the improved and enhanced wind or fluid-flow and energy enhancer can also be added to appropriately shaped natural or man-made hills or mounds or earth berms or green roofs or bridges or above ground ‘tunnel’ structures or above ground pipes or walls or fences or wind breaks or dams or sea walls or harbour walls or buttress walls or flood protection walls or noise barrier walls including where appropriate under water variants used to utilise underwater currents with water current turbines. The dual-pitched or dual-sloped host structures or objects can also be in the form of walls with steeply inclined slope angles close to vertical or even vertical in the case of walls with narrow cross sectional width or thickness relative to wall height.

Other building-mounted variants include improved and enhanced mono planar wind or fluid-flow and energy enhancers consisting of Mono-directional or Dual-directional or Bi-directional improved planes or multi-element planes designed to be fitted to the sloping roof surface or to the eaves lines or verge lines or mansard edge or to valleys or to roof-lights or to parapets of pitched or curved roofs. One or more wind turbines or fluid turbines or other forms of fluid energy converters. 2, are located at or near the region of highest fluid velocity to extract power from the accelerated wind or fluid flow between Side A of the improved and enhanced mono planar wind or fluid-flow and energy enhancers and the structure to which they are attached.

Flat roof-mounted variants (see some examples in FIGS. 17 and 18) include improved and enhanced mono planar wind or fluid-flow and energy enhancers consisting of Mono-directional or Dual-directional or Bi-directional improved planes or multiple element planes designed to be fitted at a position above a flat roof or to the eaves line or to the parapets of, flat roofs. Other flat roof variants include the addition of prismatic structures or plinth walls with straight or inclined or curved sides and with a cap of curved or sloped cross sectional profile, above which improved and enhanced mono planar wind or fluid-flow enhancers consisting of Mono-directional or Dual-directional or Bi-directional improved planes or multiple element planes are aligned with and fitted to. One or more wind turbines or fluid turbines or other forms of fluid energy converters, 2, are located at or near the region of highest wind or fluid velocity to extract power from the accelerated wind or fluid flow between Side A of the improved and enhanced mono planar wind or fluid-flow and energy enhancers and the structure to which they are attached.

In the case of ridge and furrow type roofs, saw-tooth or ‘north-light’ profile roofs or monitor roofs or wave form roofs, improved and enhanced mono planar wind or fluid-flow and energy enhancers consisting of Mono-directional or Dual-directional or Bi-directional improved planes or multiple element planes may be fitted at a position above one or more of the ridges or highest regions of these roof forms. Wind energy converters, 2 are located between the improved and enhanced mono planar wind or fluid flow and energy enhancers and the crests or roof ridges. Additionally supplementary wind energy converters can be positioned in the ‘furrows’ of these roof forms to capture wind flows parallel to the furrow line. When the profiles of the ridge-and-furrow type roofs, saw-tooth or ‘north-light’ profile roofs or wave-form roofs are inclined or curved in the manner of a barrel-vault, the improved and enhanced mono planar wind or fluid flow and energy enhancers and turbines would be inclined or shaped to follow the sloping or curved ‘ridge’ lines.

In the case of conical or conical-frustrum shaped roofs, several sets of improved and enhanced mono planar wind or fluid-flow and energy enhancers consisting of Mono-directional or Dual-directional or Bi-directional improved planes or multiple element planes may be fitted at a position above the roof and be shaped to follow the roof slope of the conical surface between the top of the roof and the base of the cone or conical-frustrum. Wind energy converters are located between the mono planar wind or fluid-flow enhancers and the surface of the conical roof or conical-frustrum roof.

In the case of conical or conical frustrum shaped roofs, improved and enhanced mono planar wind or fluid-flow and energy enhancers consisting of Mono-directional or Dual-directional or Bi-directional improved planes or multiple element planes may also be fitted at a position above the roof and be shaped to follow a circular path concentric with the radial centre of the cone. Wind turbines or wind energy converters are located between the mono planar enhancers and the surface of the conical roof or conical-frustrum roof.

In the case of multi-sided pointed roofs or truncated multi-sided multi-pitched roofs, sets of improved and enhanced mono planar wind or fluid-flow and energy enhancers consisting of Mono-directional or Dual-directional or Bi-directional improved planes or multiple element planes may be fitted at a position above the roof and be shaped to follow the ‘hip line’ edges between the roof pinnacle or top of the roof and the roof eaves. Alternatively the improved and enhanced mono planar enhancers may be shaped and configured to follow the roof slope of the inclined surface between the roof pinnacle or top of the roof and the roof eaves. Wind turbines or wind energy converters are located between the mono planar wind or fluid-flow enhancers and the surface of the roof.

Corner-mounted or wall mounted or side-mounted or end-mounted improved and enhanced mono planar wind or fluid-flow and energy enhancers (see some examples FIG. 19) consisting of Mono-directional or Dual-directional or Bi-directional improved planes or multi-element planes are designed to be aligned vertically and fitted to the corners or sides or ends of other objects or buildings of two or more storeys or columns or masts or towers or chimneys or ventilation towers or silos or tanks or storage vessels or accumulators or similar structures with a range of plan section shapes including circular, elliptical, kidney shape, heart shape, pear shape, egg shape, banana shape, crescent, circular chord or segment, semicircle, quadrant, circular sector, semi-elliptical, parabola, triangular, rectangular, diamond, lozenge, parallelogram, rhombus, flat oval, regular polygon shapes, irregular polygon shapes, sculpted shapes plus ‘X’, ‘Y’ and star shape plans or a combination of these. Wind turbines or fluid turbines or other wind or fluid energy converters are located between the mono-planar enhancers and the surface of the attached structure. If the host object or building is shaped with a taper or twist or both a twist and taper along its longitudinal dimension the corner-mounted or wall-mounted or side-mounted or end-mounted improved and enhanced mono-planar wind or fluid-flow enhancers can be shaped and configured to be aligned with the tapered and/or twisted path of the corners or sides or ends of the host object or building.

If the host roof or host object has a surface with double curvature (e.g. either synclastic or anticlastic or ‘free-form’ types) then the improved and enhanced building-mounted or object-mounted linear wind or fluid-flow and energy enhancers can be shaped to follow the curvature of the roof surface if appropriate. One or more wind turbines or fluid turbines or other form of fluid energy converters are, 2 located between Side A of the improved and enhanced planes and the curved surface.

If the host building or object has a curved surface then the improved and enhanced building-mounted or object-mounted linear wind or fluid-flow and energy enhancers can be shaped to follow can be shaped to follow a helical path around the surface curvature of the host building or object. One or more wind turbines or fluid turbines or other form of fluid energy converters are, 2, located between Side A of the improved and enhanced planes and the curved surface of the host building or object.

n. Improved and Enhanced Device Having Structure-Integrated Movable Wind or Fluid-Flow and Energy Enhancers

These improved and enhanced linear wind or fluid-flow and energy enhancers are essentially the same as the previously described improved and enhanced wind or fluid-flow and energy enhancers except that part or all of the improved and enhanced linear surfaces are collectively or individually movable by sliding or rotation.

o. Improved and Enhanced Device Having Wind or Fluid-Flow Energy Enhancer for Vehicle Propulsion

Improved and enhanced linear wind-flow and energy enhancers of the above types in combination with wind turbines can be used to propel surface or near surface vehicles such as wind driven wheeled vehicles or wind turbine driven boats. In this device the energy extracted from the accelerated wind is converted to mechanical power via wind turbines located between the improved and enhanced linear wind-flow and energy enhancers which is then used to rotate a water propeller or impeller either by mechanical means or hydraulic means or pneumatic means or via an electrical generator and electric motor. Using improved and enhanced linear wind-flow and energy enhancers encloses the turbine/s and reduces the turbines' size further making this application more viable and more feasible. Land vehicles could be powered in a similar way except the power is transmitted to wheels or tracks.

The improved and enhanced linear wind and energy enhancers can be configured such that the y-Axis is vertical or horizontal or an angle or angles in between. When the y-Axis is vertical the improved and enhanced linear enhancers can additionally be deployed as a kind of aerodynamic sail to propel the vehicle directly by exerting a side force when subject to wind forces in the manner of a normal sail.

The improved and enhanced planes can also be configured in a ‘swept’ configuration such that the planes are aligned with an angle between the y-Axis and the z-Axis. The improved and enhanced planes can also be configured in a ‘dihedral’ arrangement or in an ‘anhedral’ configuration with the planes aligned with an angle between the y-Axis and the x-Axis. The improved and enhanced planes can also be configured in a ‘polyhedral’ configuration or in an ‘gull-wing’ configuration or in a ‘curved polyhedral’ configuration about the z-Axis. One or more of the improved and enhanced planes or multiple element planes can also be configured with a built-in ‘twist’ or ‘warp’ about an axis in line with or parallel to the y-Axis between each end of the plane or between either end of the plane and a mid region of the plane. The improved and enhanced planes can be configured so that ‘twisting’ or ‘warping’ could be adjustable.

In the case of boats the water driven versions of the device can also be used to extract energy from underwater water currents when immersed in the water.

1. An energy enhancing device for increasing the effectiveness of energy conversion from wind and other fluid flows comprising one or more cylindrical forms of cross-flow flow turbines which operate with aerodynamic lift forces or with aerodynamic drag forces and an improved wind or fluid flow and energy enhancing means for accelerating the wind or fluid flow and directing said accelerated flow onto said turbine, said improved enhancing means being defined by at least one straight or curved or bent linear member which consists of one or more secondary linear members each of which has a cross-sectional profile consisting of a leading edge, a trailing edge and at least two sides; Side A and Side B, the first of said sides (Side A) is located adjacent to the said cylindrical cross flow turbine, Side A consisting of a flat side extending between said leading edge and said trailing edge or a continuously convex side extending between said leading edge and said trailing edge or a convex faceted shaped side extending between said leading edge and said trailing edge or a combination of flat and curved regions between said leading edge and said trailing edge, the surface of Side A may additionally incorporate riblets or dimpling or vortex generators or turbulators to influence the wind flow or fluid flow behaviour over the surface, the second of the said sides (Side B) of the said secondary linear member consists of a flat side extending between said leading edge and said trailing edge or continuously concave side extending between said leading edge and said trailing edge or concave faceted side extending between said leading edge and said trailing edge or continuously convex side extending between said leading edge and said trailing edge or convex faceted side extending between said leading edge and said trailing edge or largely ‘S’ shaped ‘concave to convex curve’ shaped side extending between said leading edge and said trailing edge or a combination of flat and curved regions between said leading edge and said trailing edge, said leading edge of the said secondary linear member may be sharp or blunt or rounded and may include appendages intended to further accelerate the wind flow or fluid flow for enhanced energy extraction or conversely to degrade fluid flow, said trailing edge of the said secondary linear member may be sharp or blunt or rounded and may include appendages intended to further accelerate the wind flow or fluid flow for enhanced energy extraction, said secondary linear member when viewed from Side A or Side B has a longitudinal axis extending parallel to the axis of rotation of said turbine, said secondary linear member when viewed from the said leading edge has a longitudinal axis which may be parallel to the axis of rotation of said turbine or inclined in relation to the axis of rotation of said turbine or curved to follow a convex path or concave path or faceted path in relation to the axis of rotation of said turbine, said leading edge of said secondary linear member when viewed from Side A or Side B may be parallel to the longitudinal axis of the said secondary linear member or may be inclined in relation to said longitudinal axis or may follow a curved path in relation to said longitudinal axis or may follow a faceted path in relation to the longitudinal axis, said trailing edge of said secondary linear member when viewed from Side A or Side B may be parallel to the longitudinal axis of the said secondary linear member or may be inclined in relation to said longitudinal axis or may follow a curved path in relation to said longitudinal axis or may follow a faceted path in relation to the longitudinal axis, said secondary linear member may be twisted or warped by an angle greater than plus or minus one degree about its longitudinal axis between each end or between a mid region and either end, either end or tip of the said linear member or said secondary linear member or members may be square-cut or bevelled or rounded when viewed from Side A or Side B or may have end plates attached or may have winglets or tip sails or other tip appendages attached to improve the fluid flow for enhanced energy extraction.

2. An energy enhancing device for increasing the effectiveness of energy conversion from wind and other fluid flows comprising one or more axial-flow turbines and an improved and enhanced wind or fluid flow and energy enhancing means for accelerating the wind or fluid flow and directing said accelerated flow onto said turbine, said enhancing means being defined by at least one straight or curved or bent linear member which consists of one or more secondary linear members each of which has a cross-sectional profile consisting of a leading edge, a trailing edge and at least two sides; Side A and Side B, the first of said sides (Side A) is located adjacent to the said axial-flow turbines, Side A consisting of a flat side extending between said leading edge and said trailing edge or a continuously convex side extending between said leading edge and said trailing edge or a convex faceted shaped side extending between said leading edge and said trailing edge or a combination of flat and curved regions between said leading edge and said trailing edge, the surface of Side A may additionally incorporate riblets or dimpling or vortex generators or turbulators to influence the wind flow or fluid flow behaviour over the surface, the second of the said sides (Side B) of the secondary linear member consists of a flat side extending between said leading edge and said trailing edge, or continuously concave side extending between said leading edge and said trailing edge or concave faceted side extending between said leading edge and said trailing edge or continuously convex side extending between said leading edge and said trailing edge or convex faceted side extending between said leading edge and said trailing edge or largely ‘S’ shaped ‘concave to convex curve’ shaped side extending between said leading edge and said trailing edge or a combination of flat and curved regions between said leading edge and said trailing edge, said leading edge of the said secondary linear member may be sharp or blunt or rounded and may include appendages intended to further accelerate the wind flow or fluid flow for enhanced extraction or to degrade the fluid flow, said trailing edge of the said secondary linear member may be sharp or blunt or rounded and may include appendages intended to further accelerate the wind flow or fluid flow for enhanced energy extraction, said secondary linear member when viewed from Side A or Side B has a longitudinal axis extending in a line at 90 degrees to the axis of rotation of the said turbine and at 90 degrees to the normal plane of rotation of said turbine when the fluid flow direction is at 90 degrees to the leading edge of the linear member when viewed from Side B, said secondary linear member when viewed from the said leading edge or said trailing edge has a longitudinal axis which may be parallel to a line drawn between the axes of rotation of one or more said turbines arranged as a ‘row’ of turbines or as a ‘stack’ of turbines or inclined in relation to a line drawn between the axes of rotation of one or more said turbines arranged as a ‘row’ of turbines or as a ‘stack’ of turbines or curved to follow a convex path or concave path or faceted path in relation to a line drawn between the axes of rotation one or more said turbines arranged as a ‘row’ of turbines or as a ‘stack’ of turbines, said leading edge of said secondary linear member when viewed from Side A or Side B may be parallel to the longitudinal axis of the said secondary linear member or may be inclined in relation to said longitudinal axis or may follow a curved path in relation to said longitudinal axis or may follow a faceted path in relation to the longitudinal axis, said trailing edge of said secondary linear member when viewed from Side A or Side B may be parallel to the longitudinal axis of the said secondary linear member or may be inclined in relation to said longitudinal axis or may follow a curved path in relation to said longitudinal axis or may follow a faceted path in relation to the longitudinal axis, said secondary linear member may be twisted or warped by an angle greater than plus or minus one degree about its longitudinal axis between each end or between a mid region and either end, either end or tip of the said linear member or said secondary linear member or members may be square-cut or bevelled or rounded when viewed from Side A or Side B or may have end plates attached or may have winglets or tip sails or other tip appendages attached to improve the fluid flow for enhanced energy extraction.

3. An energy enhancing device for increasing the effectiveness of energy conversion from wind and other fluid flows comprising one or more cylindrical forms of cross-flow flow turbines which operate with aerodynamic lift forces or with aerodynamic drag forces and an improved and enhanced wind or fluid flow and energy enhancing means for accelerating the wind or fluid flow and directing said accelerated flow onto said turbine or turbines, said enhancing means being defined by at least one straight or curved or bent linear member which consists of one or more secondary linear members each of which has a cross-sectional profile consisting of a leading edge, a trailing edge and at least two sides; Side A and Side B, the first of said sides (Side A) is located adjacent to the said cylindrical cross flow turbine or turbines, Side A consisting of a flat side extending between said leading edge and trailing edge or continuously convex side extending between said leading edge and trailing edge or convex faceted shaped side extending between said leading edge and trailing edge or a combination of flat and curved regions between said leading edge and trailing edge, the surface of Side A may additionally incorporate riblets or dimpling or vortex generators or turbulators to influence the wind flow or fluid flow behaviour over the surface, the second of the said sides (Side B) of the secondary linear member consists of a flat side extending between said leading edge and trailing edge, or continuously concave side extending between said leading edge and trailing edge or concave faceted side extending between said leading edge and trailing edge or continuously convex side extending between said leading edge and trailing edge or convex faceted side extending between said leading edge and trailing edge or largely ‘S’ shaped ‘concave to convex curve’ shaped side extending between said leading edge and trailing edge or a combination of flat and curved regions between said leading edge and trailing edge, said leading edge of the secondary linear member may be sharp or blunt or rounded and may include appendages intended to further accelerate the wind flow or fluid flow for enhanced energy extraction, said trailing edge of the secondary linear member may be sharp or blunt or rounded and may include appendages intended to further accelerate the wind flow or fluid flow for enhanced energy extraction, said secondary linear member when viewed from Side A or Side B has a longitudinal axis extending parallel to the plane of rotation of said turbines, said secondary linear member when viewed from the leading edge or trailing edge has a longitudinal axis which may be parallel to the plane of rotation of said turbine or turbines or inclined in relation to the plane of rotation of said turbine or turbines or curved to follow a convex path or concave path or faceted path in relation to the plane of rotation of said turbine or turbines, said leading edge of said secondary linear member when viewed from Side A or Side B may be parallel to the longitudinal axis of the said secondary linear member or may be inclined in relation to said longitudinal axis or follow a curved path in relation to said longitudinal axis or follow a faceted path in relation to the longitudinal axis, said trailing edge of said secondary linear member when viewed from Side A or Side B may be parallel to the longitudinal axis of the said secondary linear member or may be inclined in relation to said longitudinal axis or follow a curved path in relation to said longitudinal axis or follow a faceted path in relation to the longitudinal axis, said secondary linear member may be twisted or warped by an angle greater than plus or minus one degree about its longitudinal axis between each end or between a mid region and either end, either end or tip of the said linear member or said secondary linear member or members may be square-cut or bevelled or rounded when viewed from Side A or Side B or may have end plates attached or may have winglets or tip sails or other tip appendages attached to improve the fluid flow for enhanced energy extraction.

4. An improved and enhanced device as claimed in claims 1 and 3, but with the cross flow turbine being of the type known as the curved blade Darrieus type turbine which has one or more long aerofoil type blades configured to follow a curved path in the form of an arch shape or in the form of a skipping rope such that one end of said blade is attached at one end of the turbine shaft and the other end of said blade is attached to the opposite end of said turbine shaft.

5. An improved and enhanced device as claimed in claims 1 and 3, but with the cross flow turbine being of the V-type cross flow turbine which has one or more long aerofoil type blades configured in the form of a letter Vee such that one end of said blade is attached to one end of the turbine shaft and the blade itself is inclined relative to the turbine's rotation axis such that when the turbine rotates it sweeps a conical surface.

6. Improved and enhanced device and devices as claimed in claim 1, claim 2, claim 3, claim 4 and claim 5 wherein said linear members of improved and enhanced said device consists of an aerodynamic high lift device to further enhance energy extraction by further accelerating the wind flow or fluid flow through the adjacent turbine or turbines, said high lift device consists of a wing shaped linear member with a profile in the form of a highly cambered aerofoil in which the convex Side A of said linear member is adjacent to the said turbine or turbines and for optimum performance the rounded leading edge is oriented towards the direction of wind or fluid flow.

7. Improved and enhanced device and devices as claimed in claim 1, claim 2, claim 3, claim 4, and claim 5 wherein said linear members of improved and enhanced said device consist of an aerodynamic high lift device to further enhance energy extraction by further accelerating the wind flow or fluid flow through the adjacent turbine or turbines by improving flow attachment over the linear member, said high lift device consists of a wing shaped linear member with a profile in the form of a multiple element wing consisting of a cambered aerofoil profile shaped wing and attached to the trailing edge of said cambered aerofoil are one or more trailing edge flaps and one or more slots or gaps between said flaps, said trailing edge flaps may be of aerofoil section or of curved or flat plate profile, the convex Side A of said linear member is adjacent to the said turbine or turbines and for optimum performance the rounded leading edge is oriented towards the direction from which the wind or fluid flow approaches the said device.

8. Improved and enhanced device and devices as claimed in claim 1, claim 2, claim 3, claim 4 and claim 5 wherein said linear members of improved and enhanced said device consist of an aerodynamic high lift device to further enhance energy extraction by further accelerating the wind flow or fluid flow through the adjacent turbine or turbines by improving flow attachment over the linear member, said high lift device consists of a wing shaped linear member with a profile in the form of a multiple element wing consisting of a cambered aerofoil profile shaped wing combined with an aerodynamic leading edge slat attached including the type called the Handley Page Slat and attached to the trailing edge of said cambered aerofoil are one or more trailing edge flaps and one or more slots or gaps between said flaps, said trailing edge flaps may be of aerofoil section or of curved or flat plate profile, the convex Side A of said linear member is adjacent to the said turbine or turbines and for optimum performance the rounded leading edge is oriented towards the direction of wind or fluid flow.

9. Improved and enhanced device and devices as claimed in claim 1, claim 2, claim 3, claim 4, claim 5, claim 6, claim 7, claim 8, claim 10, claim 11, claim 12 and claim 13 wherein said linear member of improved and enhanced said device is combined with a perpendicular or near perpendicular strip shaped appendages variously known as a Gurney Flap or Wicker Flap or an appendage known as an aileron or a ‘fishtail edge’ or other spoiler type appendages attached to its trailing edge and or attached to its leading edge to help to maintain flow attachment to further enhance energy extraction by further accelerating the wind flow or fluid flow through the adjacent turbine or turbines.

10. Improved and enhanced device and devices as claimed in claim 1, claim 2, claim 3, claim 4, claim 5, claim 6, claim 7, claim 8, claim 9, claim 11, claim 12 and claim 13 wherein said linear members of improved and enhanced said device consist of an aerodynamic high lift device further enhance energy extraction by further accelerating the wind flow or fluid flow through the adjacent turbine or turbines, said high lift device consists of employing aerodynamic boundary control to reduce flow separation and maintain laminar or near laminar flow and thus maintain wind or fluid flow velocity, said aerodynamic boundary control may be achieved by blowing air or other fluid out of the surface through Side A or Side B of the linear member.

11. Improved and enhanced device and devices as claimed in claim 1, claim 2, claim 3, claim 4, claim 5, claim 6, claim 7, claim 8, and claim 9, claim 10, claim 12 and claim 13 wherein said linear members of improved and enhanced said device consist of an aerodynamic high lift device to further enhance energy extraction by further accelerating the wind flow or fluid flow through the adjacent turbine or turbines, said high lift device consists of employing aerodynamic boundary control to reduce flow separation and maintain laminar or near laminar flow and thus maintain wind or fluid flow velocity, said boundary layer control is achieved by the suction of air or other fluid out of the surface through Side A or Side B of the linear member.

12. Improved and enhanced device and devices as claimed in claim 1, claim 2, claim 3, claim 4, claim 5, claim 6, claim 7, claim 8 and claim 9 wherein said linear members of improved and enhanced said device consist of an aerodynamic high lift device intended to further enhance energy extraction by further accelerating the wind flow or fluid flow through the adjacent turbines or turbines by improving flow attachment to the linear member, said high lift device consists of employing a Cusp or Step Change in the surface shape of Side A or Side B of linear members, the use of a Cusp or Step Change improves boundary layer flow and thus helps to maintain wind or fluid flow velocity over the linear member and through the turbine or turbines.

13. Improved and enhanced device and devices as claimed in claim 1, claim 2, claim 3, claim 4, claim 5, claim 6, claim 7, claim 8, claim 9 and claim 12 wherein said linear members of improved and enhanced said device consist of an aerodynamic high lift device to further enhance energy extraction by further accelerating the wind flow or fluid flow through the adjacent turbines or turbines by improving flow attachment to the linear member, said high lift device consists of employing an appropriately shaped concave cavity intended to trap vortices in order to prevent vortex shedding to improve the high lift characteristics of thicker profile section versions of the linear members and help to maintain laminar flow over the surface of the linear member and thus help to maintain wind or fluid flow velocity over the linear member and through the turbine or turbines, for optimum performance the vortex trapping cavity is best when located in Side A of the linear member but can be incorporated into Side B.

14. An improved and enhanced device as claimed in claim 1, claim 2, claim 3, claim 4, claim 5, claim 6, claim 7, claim 8, claim 9, claim 11, claim 10, claim 12 and claim 13, but configured such that the linear members and or the secondary linear members can be moved independently or collectively by rotation about an axis parallel to the longitudinal axis of the device, the said linear members and or the secondary linear members can additionally be moved independently or collectively by a sliding motion, the said linear members and or the secondary linear members can additionally be altered independently or collectively by means of adjustable twisting or warping about an axis parallel to the longitudinal axis of the device.

15. An improved and enhanced device as claimed in claim 1, claim 2, claim 3, claim 4, claim 5, claim 6, claim 7, claim 8, claim 9, claim 11, claim 10, claim 12 and claim 13, but configured such that the linear member of the device is shaped to follow a helical path with the sweep axis of the helix so described aligned with the longitudinal axis or parallel to the said longitudinal axis.

16. Two improved and enhanced devices as claimed in claim 1, claim 6, claim 7, claim 8, claim 9, claim 10, claim 11, claim 12, claim, claim 13 and claim 14 arranged to be adjacent to each other such that the leading edge of the first of the said improved and enhanced devices faces the leading edge of the second of the said improved and enhanced devices and arranged such that when the wind flow or fluid flow is approaching towards the first of the said improved and enhanced devices the said first device is located upstream of the second of the two said devices and the trailing edge of the linear member of the said first device is upstream of the leading edge of the linear member of the said first device, when the wind flow or fluid flow is approaching towards the said second device the second device is upstream of the said first device, the leading edge of the linear member of the said first device faces the leading edge of the linear member of the said second device, Side A of linear member of the said first device and Side A of linear member of the second device are located adjacent to said cross-flow turbine or turbines as claimed in claim 1 or claim 4 or claim 5.

17. Two improved and enhanced devices as claimed in claim 2, claim 6, claim 7, claim 8, claim 9, claim 10, claim 11, claim 12, claim, claim 13 and claim 14 arranged to be adjacent to each other such that the leading edge of the first of the said improved and enhanced devices faces the leading edge of the second of the said improved and enhanced devices and arranged such that when the wind flow or fluid flow is approaching towards the first of the said devices the said first device is located upstream of the second of the two said devices and the trailing edge of the linear member of the said first device is upstream of the leading edge of the linear member of the said first device, when the wind flow or fluid flow is approaching towards the said second device the said second device is upstream of the said first device, the leading edge of the linear member of the said first device faces the leading edge of the linear member of the said second device, Side A of linear member of the said first device and Side A of linear member of the said second device are located adjacent to said axial-flow turbine or turbines.

18. Two improved and enhanced devices as claimed in claim 3, claim 4 and claim 5, claim 6, claim 7, claim 8, claim 9, claim 10, claim 11, claim 12, claim 13 and claim 14 arranged to be adjacent to each other such that the leading edge of the first of the said improved and enhanced devices faces the leading edge of the second of the said improved and enhanced devices and arranged such that when the wind flow or fluid flow is approaching the first of the said devices the said first device is located upstream of the second of the two said devices and the trailing edge of the linear member of the said first device is upstream of the leading edge of the linear member of the said first device, when the wind flow or fluid flow is approaching the said second device the said second device is upstream of the said first device, the leading edge of the linear member of the said first device faces the leading edge of the linear member of the said second device, Side A of linear member of the said first device and Side A of linear member of the second device are located adjacent to said cross-flow turbine or turbines as claimed in claim 3 or claim 4 or claim 5.

19. Two improved and enhanced devices as claimed in claims 16, claim 17 and claim 18, but configured such that the linear members of the said device are each shaped as helically shaped members which follow a helical path with the sweep axis of the helix so described aligned with the longitudinal axis or parallel to the said longitudinal axis, said turbines are located adjacent to Side A of the said helical device.

20. Two improved and enhanced devices as claimed in claim 1, claim 6, claim 7, claim 8, claim 9, claim 10, claim 11, claim 12, claim 13 and claim 14 arranged to be adjacent to each other such that Side A of linear member of the first of said devices faces Side A of linear member of the second of said devices and said cross flow turbine or turbines as claimed in claim 1, claim 4 or claim 5 are located between Side A of linear member of the said first device and Side A of linear member of the said second device.

21. Two improved and enhanced devices as claimed in claim 2, claim 6, claim 7, claim 8, claim 9, claim 10, claim 11, claim 12, claim 13 and claim 14 arranged to be adjacent to each other such that Side A of linear member of the first of said devices faces Side A of linear member of the second of said devices and said axial-flow turbine or turbines are located between Side A of linear member of the said first device and Side A of linear member of the said second device.

22. Two improved and enhanced devices as claimed in claim 3, claim 4, claim 5 and claim 6, claim 7, claim 8, claim 9, claim 10, claim 11, claim 12, claim 13 and claim 14 arranged to be adjacent to each other such that Side A of linear member of the first of said devices faces Side A of linear member of the second of said devices and said cross flow turbine or turbines as claimed in claim 3 or claim 4 or claim 5 are located between Side A of linear member of the said first device and Side A of linear member of the said second device.

23. Two improved and enhanced helical devices as claimed in claim 15, arranged to be adjacent to each other such that Side A of the helically shaped linear member of the said first helical device faces Side A of helically shaped linear member of the said second helical device but configured such that the helically shaped linear members of the said first helical device are each shaped to follow a helical path with the sweep axis of the helix so described aligned with the longitudinal axis or parallel to the said longitudinal axis, said turbine or turbines are located between Side A of the helically shaped linear member of the said first helical device and Side A of the helically shaped linear member of the said second helical device.

24. Two improved and enhance devices as claimed in claim 20, claim 21, claim 22 and claim 23, claim 32, claim 33 and claim 34 with the addition of a third linear component consisting of one linear member located between the other two devices such that the longitudinal axis of said third linear component is parallel to the longitudinal axis of the said first device and parallel to the longitudinal axis of the said second device; Side A of the said first device faces Side B of the said third linear component, Side A of the said first device also faces said turbine or turbines, Side A of the said second device faces Side A of the said third linear component, Side A of the second said device also faces said turbine or turbines, said third linear component consists of an linear member, said linear member of the third linear component consists of a leading edge and a trailing edge plus two sides (Side A and Side B), the leading edge of said third linear component is parallel to the leading edge of the said first device and parallel to the leading edge of said second device, the trailing edge of said third linear component is parallel to the trailing edge of the said first device and parallel to the trailing edge of said second device, the shape of Side A of the said third linear component is symmetrically similar to Side B of the said third linear component about an axis of symmetry along the lateral axis of the linear member of the said third linear component, the third linear component is located to one side of said turbine or turbines and positioned with the trailing edge of said third linear component facing said turbine or turbines.

25. Two improved and enhanced devices as claimed in claim 20, claim 21, claim 22, claim 32, claim 33 and claim 34 with at least two sets of turbines (turbine set A and turbine set B) and the addition of a third linear component consisting of one linear member located between the other two devices such that the longitudinal axis of said third linear component is parallel to the longitudinal axis of the said first device and parallel to the longitudinal axis of the said second device; Side A of the said first device faces Side B of the said third linear component, Side A of the said first device also faces said turbine set A, Side A of the said second device faces Side A of the said third linear component, Side A of the said second device also faces said turbine set B, said third linear component consists of an linear member, said linear member of the said third linear component consists of a leading edge and a trailing edge plus two sides (Side A and Side B), the leading edge of said third linear component is parallel to the leading edge of the said first device and parallel to the leading edge of said second device, the trailing edge of said third linear component is parallel to the trailing edge of the said first device and parallel to the trailing edge of said second device, the shape of Side A of the said third linear component is symmetrically similar to Side B of the said third linear component about an axis of symmetry along the lateral axis of the linear member of the said third linear component, Side A of the said third linear component faces said turbine set B, Side B of the said third linear component faces said turbine set A, said turbine set A consists of at least one axial-flow turbine or at least one cross flow turbine or at least two turbines arranged in a row or in a stack, said turbine set B consists of at least one axial flow turbine or at least one cross flow turbine or at least two turbines arranged in a row or in a stack.

26. Two improved and enhanced devices as claimed in claim 20, claim 21 and claim 22 but instead are located adjacent to a separate adjacent object such that the said leading edge of the said first device faces the adjacent object and said leading edge of the said second device faces the adjacent object, said leading edge of said first device is positioned a small distance from said adjacent object, said leading edge of said second device is positioned a small distance from said adjacent object, said first device and said second device are arranged to be adjacent to each other such that Side A of linear member of the said first device faces Side A of linear member of the said second device and said turbine or turbines are located between Side A of linear member of the said first device and Side A of linear member of the said second device.

27. Two improved and enhanced devices as claimed in claim 20, claim 21 and claim 22 but arranged so that the longitudinal axes of the linear member or secondary linear members of the said devices are vertical, said devices are adjacent to and attached to another separate adjacent linear object and positioned a small distance from said adjacent linear object, said leading edge of the said first device faces the adjacent linear object and said leading edge of the said second device faces the adjacent object, said leading edge of said first device is positioned a small distance from said adjacent object, said leading edge of said second device is positioned a small distance from said adjacent object, said longitudinal axis of linear members of said first device is parallel to the longitudinal axis of said adjacent linear object, said longitudinal axis of linear members of said second device is parallel to the longitudinal axis of said adjacent linear object, said first device and said second device are arranged to be adjacent to each other such that Side A of linear member of the said first device faces Side A of linear member of the said second device and said turbine or turbines are located between Side A of linear member of the said first device and Side A of linear member of the said second device, said adjacent linear object can be a wall or fence or column or tower or mast or chimney or silo or building corner or building side or surface vehicle.

28. Two improved and enhance devices as claimed in claim 20, claim 21 and claim 22 but arranged so that the longitudinal axes of the linear members or secondary linear members of the said devices are horizontal, the lateral axis of said devices is vertical or close to vertical, said leading edge of said first device is horizontal, said leading edge of said second device is horizontal, said devices are located adjacent to and attached to another separate adjacent linear object and positioned a small distance from said adjacent linear object, said leading edge of the said first device faces the adjacent linear object and said leading edge of the said second device faces the adjacent object, said leading edge of said first device is positioned a small distance from said adjacent object, said leading edge of said second device is positioned a small distance from said adjacent object, said longitudinal axis of linear members of said first device is parallel to the longitudinal axis of said adjacent linear object, said longitudinal axis of linear members of said second device is parallel to the longitudinal axis of said adjacent linear object, said first device and said second device are arranged to be adjacent to each other such that Side A of linear member of the said first device faces Side A of linear member of the said second device and said turbine or turbines are located between Side A of linear member of the said first device and Side A of linear member of the said second device, said adjacent linear object can be a hill or ridge or berm or bridge or building roof or building eaves or canopy or pergola or shelter or tent or surface vehicle or top of a wall or top of a parapet or top of a fence.

29. Two improved and enhance devices as claimed in claim 20, claim 21 and claim 22 but instead located adjacent to a separate adjacent object such that the said trailing edge of the said first device faces the adjacent object and said trailing edge of the said second device faces the adjacent object, said trailing edge of said first device is positioned a small distance from said adjacent object, said trailing edge of said second device is positioned a small distance from said adjacent object, said first device and said second device are arranged to be adjacent to each other such that Side A of linear member of the said first device faces Side A of linear member of the said second device and said turbine or turbines are located between Side A of linear member of the said first device and Side A of linear member of the said second device.

30. Two improved and enhance devices as claimed in claim 20, claim 21 and claim 22 but arranged so that the longitudinal axes of the linear member or secondary linear members of the said devices are vertical, said devices are adjacent to and attached to another separate adjacent linear object and positioned a small distance from said adjacent linear object, said trailing edge of the said first device faces the adjacent linear object and said trailing edge of the said second device faces the adjacent object, said trailing edge of said first device is positioned a small distance from said adjacent object, said trailing edge of said second device is positioned a small distance from said adjacent object, said longitudinal axis of linear members of said first device are parallel to the longitudinal axis of said adjacent linear object, said longitudinal axis of linear members of said second device are parallel to the longitudinal axis of said adjacent linear object, said first device and said second device are arranged to be adjacent to each other such that Side A of linear member of the said first device faces Side A of linear member of the said second device and said turbine or turbines are located between Side A of linear member of the said first device and Side A of linear member of the said second device, said adjacent linear object can be a wall or fence or column or tower or mast or chimney or silo or building corner or building side or surface vehicle.

31. Two improved and enhance devices as claimed in claim 20, claim 21 and claim 22 but arranged so that the longitudinal axes of the linear members or secondary linear members of the said devices are horizontal, the lateral axis of said devices is vertical or close to vertical, said leading edge of said first device is horizontal, said leading edge of said second device is horizontal, said devices are located adjacent to and attached to another separate adjacent linear object and positioned a small distance from said adjacent linear object, said trailing edge of the said first device faces the adjacent linear object and said trailing edge of the said second device faces the adjacent object, said trailing edge of said first device is positioned a small distance from said adjacent object, said trailing edge of said second device is positioned a small distance from said adjacent object, said longitudinal axis of linear members of said first device is parallel to the longitudinal axis of said adjacent linear object, said longitudinal axis of linear members of said second device is parallel to the longitudinal axis of said adjacent linear object, said first device and said second device are arranged to be adjacent to each other such that Side A of linear member of the said first device faces Side A of linear member of the said second device and said turbine or turbines are located between Side A of linear member of the said first device and Side A of linear member of the said second device, said adjacent linear object can be a hill or ridge or berm or bridge or building roof or building eaves or canopy or pergola or shelter or tent or surface vehicle or top of a wall or top of a parapet or top of a fence.

32. Four improved and enhanced devices as claimed in claim 1, claim 6, claim 7, claim 8, claim 9, claim 10, claim 11, claim 12, claim, claim 13 and claim 14 configured as two pairs of two devices as claimed in claim 16, arranged to be adjacent to each other such that Side A of the linear members of the first pair of said devices faces Side A of linear members of the second pair of said devices and said cross flow turbine or turbines as claimed in claim I or claim 4 or claim 5 are located between Side A of linear members of the first pair of said devices and Side A of linear members of the second pair of said devices.

33. Four improved and enhanced devices as claimed in claim 2, claim 6, claim 7, claim 8, claim 9, claim 10, claim 11, claim 12, claim, claim 13 and claim 14 configured as two pairs of two devices as claimed in claim 17, arranged to be adjacent to each other such that Side A of the linear members of the first of pair said devices faces Side A of linear members of the second pair of said devices and said axial-flow turbine or turbines are located between Side A of linear members of the first pair of said devices and Side A of linear members of the second pair of said devices.

34. Four improved and enhanced devices as claimed in claim 3, claim 4 and claim 5, claim 6, claim 7, claim 8, claim 9, claim 10, claim 11, claim 12, claim, claim 13 and claim 14 configured as two pairs of two devices as claimed in claim 18, arranged to be adjacent to each other such that Side A of the linear members of the first of pair of said devices faces Side A of linear members of the second pair of said devices and said cross flow turbine or turbines as claimed in claim 3 or claim 4 or claim 5 are located between Side A of linear members of the first pair of said devices and Side A of linear members of the second pair of said devices.

35. Four improved and enhanced helical devices as claimed in claim 15 configured as two pairs of two helical devices as claimed in claim 23, arranged to be adjacent to each other such that Side A of the helically shaped linear members of the first pair of said helical devices faces Side A of the helically shaped linear members of the second pair of said helical devices and configured such that the helically shaped linear members of the said device are each shaped to follow a helical path with the sweep axis of the helix so described aligned with the longitudinal axis or parallel to the said longitudinal axis, said turbine or turbines are located between Side A of the helically shaped linear members of the first pair of said helical devices and Side A of linear members of the second pair of said helical devices.

36a. One or more improved and enhanced devices as claimed in claim 1, claim 2, claim 3, claim 4, claim 5, claim 6, claim 7, claim 8, claim 9, claim 10, claim 11, claim 12, claim 13, claim 14, claim 15, claim 16, claim 17 and claim 18, arranged to be adjacent to and attached to another separate adjacent object and positioned at a distance from said adjacent object that is slightly greater than the diameter or maximum dimension of the said turbine so that Side A of the linear member or secondary linear members of said device faces the said adjacent object, said adjacent object can be a wall or parapet or fence or column or tower or mast or chimney or silo or hill or ridge or berm or bridge or dome or building roof or flat roof or building hip or building corner or building side or building eaves or building verge or canopy or pergola or greenhouse or shelter or loggia or tent or above ground tunnel or above ground pipes or surface vehicle or top of a wall or top of a parapet or top of a fence or top of a dam, said turbine or turbines are located between Side A of linear member of the said device and the adjacent object.

37. One or more improved and enhanced devices as claimed in claim 1, claim 2, claim 3, claim 4, claim 5, claim 6, claim 7, claim 8, claim 9, claim 10, claim 11, claim 12, claim 13, claim 14, claim 16, claim 17 and claim 18, arranged so that the linear member or secondary linear members of the said device are horizontal or near horizontal and located above and attached to another separate adjacent linear object and positioned at a distance above said adjacent linear object that is slightly greater than the diameter or maximum dimension of the said turbine and aligned with longitudinal axis of said adjacent linear object so that Side A of the linear member or secondary linear members of said device faces the said adjacent linear object, said adjacent linear object can be a hill or ridge or berm or bridge or building roof or flat roof or building eaves or canopy or pergola or greenhouse or shelter or loggia or tent or surface vehicle or top of a wall or top of a parapet or top of a fence or top of a dam, said turbine or turbines are located between Side A of linear member of the said device and the adjacent linear object.

38. One or more improved and enhanced devices as claimed in claim 1, claim 2, claim 3, claim 4, claim 5, claim 6, claim 7, claim 8, claim 9, claim 10, claim 11, claim 12, claim 13, claim 14, claim 16, claim 17 and claim 18, arranged so that the linear member or secondary linear members of the said device are vertical and located to the side of and attached to another separate adjacent linear object and positioned at a distance from said adjacent linear object that is slightly greater than the diameter or maximum dimension of the said turbine or turbines and aligned with the longitudinal axis of said adjacent linear object so that Side A of the linear member or secondary linear members of said device faces the said adjacent linear object, said adjacent linear object can be a wall or column or tower or mast or chimney or silo or tank or storage vessel or accumulators or ventilation tower or building corner or building side or building end, said turbine or turbines are located between Side A of linear member of the said device and the adjacent linear object.

39. One or more improved and enhanced helical devices as claimed in claims 15 and claim 19, arranged to be adjacent to and attached to another adjacent object and positioned at a distance from said separate adjacent object that is slightly greater than the diameter or maximum dimension of the said turbine so that Side A of the helically shaped linear member or secondary linear members of said helical device faces the said adjacent object but configured to follow a helical path around said adjacent object, said adjacent object can be a wall or parapet or fence or column or tower or mast or chimney or silo or hill or ridge or berm or bridge or dome or building roof or building hip or building corner or canopy or greenhouse or pergola or shelter or tent or surface vehicle or top of a wall or top of a parapet or top of a fence, said turbine or turbines are located between Side A of helically shaped linear member of the said helical device and the adjacent object.

40. An improved and enhanced device or devices as claimed in claim 1, claim 2, claim 3, claim 6, claim 7, claim 8, claim 9, claim 10, claim 11, claim 12, claim 13, claim 14, claim 16, claim 17, claim 1 8, claim 20, claim 21, claim 22, claim 24, claim 25, claim 26, claim 27, claim 29, claim 30, claim 32, claim 33, claim 34, claim 45, claim 46, claim 47, claim 49, claim 50, claim 51. Claim 52 and claim 53 but with the linear members of the said device being vertically aligned or individually or collectively at a dihedral or anhedral or polyhedral angle and configured such that the whole device or a part or parts of the device are able to rotate about an axis is vertical or parallel to the longitudinal axis in response to changes in the azimuth or compass direction of the wind or fluid flow as it approaches the device.

41. An improved and enhanced device as claimed in claim 1, claim 2, claim 3, claim 6, claim 7, claim 9, claim 10, claim 11, claim 12, claim 13, claim 14, claim 16, claim 17, claim 18, claim 20, claim 21, claim 22, claim 24, claim 25, claim 26, claim 28, claim 32, claim 33, claim 34, claim 45, claim 46, claim 47, claim 49, and claim 53 but with the linear members of the said device being horizontally aligned or individually or collectively at a dihedral or anhedral or polyhedral angle and configured such that in response to changes in the azimuth or compass direction of the wind or fluid flow as it approaches the device, the whole device or a part or parts of the device is able to rotate about an axis which is vertical or at 90 degrees to the longitudinal axis and at an axis at or close to 90 degrees to the lateral axis of the said device.

42. Three or more improved and enhanced devices as claimed in claim 1, claim 2, claim 3, claim 6, claim 7, claim 8, claim 9, claim 10, claim 11, claim 12, claim 13, claim 14, claim 16, claim 17 and claim 18 arranged to be vertical or at an angle between vertical and horizontal and arranged to be adjacent to each other such that Side B of each device forms one side of a composite device that takes the plan section shape of a polygon of three or more sides, the three or more devices are positioned such that there are gaps between adjacent edges of the adjacent devices through which wind or fluid flow enters and exits the composite device, Side A of each device forms a side of a polygonal void and are adjacent to said turbine or turbines as claimed in claim 1 or claim 2 or claim 3 or claim 4 or claim 5 located at a position that is in line with the centre of the polygon formed by the three or more said devices, one or more of the devices can take the form of a building that provides domestic or non-domestic accommodation.

43. Three or more improved and enhanced devices as claimed in claim 1, claim 2, claim 3, claim 6, claim 7, claim 8, claim 9, claim 10, claim 11, claim 12, claim 13, claim 14, claim 16, claim 17 and claim 18 arranged to be vertical or at an angle between vertical and horizontal and arranged to be adjacent to each other such that Side B of each device forms one side of a composite device that takes the plan section shape of a regular polygon of three or more sides, the three or more devices are positioned such that there are gaps between adjacent edges of the adjacent devices into which said turbines as claimed in claim 1 or claim 2 or claim 3 or claim 4 or claim 5 are located and through which wind or fluid flow enters and exits the composite device, Side A of each device forms a side of a polygonal void, one or more of the devices can take the form of a building that provides domestic or non-domestic accommodation.

44. A multi-stage box shaped stackable modular device which can be stacked in columns or rows using two improved and enhanced devices as claimed in claim 1, claim 2, claim 3, claim 6, claim 7, claim 8, claim 9, claim 10, claim 11, claim 12, claim 13, claim 14, claim 16, claim 17 or claim 18 arranged adjacent to each other such that Side A of linear member of the first of said devices or first pair of said devices faces Side A of linear member of the second of said devices or second pair of said devices and one or more wind turbines or fluid flow turbines as claimed in claim 1 or claim 2 or claim 3 or claim 4 or claim 5 are located between Side A of linear member of the said first device or first pair of said devices and Side A of linear member of the said second device or second pair of said devices.

45. An improved and enhanced device as claimed in claim 1, claim 2, claim 3, claim 6, claim 7, claim 8, claim 9, claim 10, claim 11, claim 12, claim 13, claim 14, claim 20, claim 21, claim 22, claim 24, claim 40 and claim 41 but with the linear members of the said device being inclined in a swept back form when viewed from side B

46. An improved and enhanced device or devices as claimed in claim 1, claim 2, claim 3, claim 6, claim 7, claim 8, claim 9, claim 10, claim 11, claim 12, claim 13, claim 14, claim 16, claim 17, claim 18, claim 20, claim 21, claim 22, claim 24, claim 25, claim 26, claim 27, claim 28, claim 29, claim 30, claim 31, claim 32, claim 33, claim 34, claim 36, claim 37, claim 38, claim 40, claim 41, claim 42, claim 43, claim 45, claim 47, claim 48, claim 49, claim 50, claim 51 and claim 52 but with the linear members of the said device or devices being twisted or warped about the longitudinal axis between each end or between either end and the mid region of said linear member or members

47. An improved and enhanced device or devices as claimed in claim 1, claim 2, claim 3, claim 6, claim 7, claim 8, claim 9, claim 10, claim 11, claim 12, claim 13, claim 14, claim 16, claim 17, claim 18, claim 20, claim 21, claim 22, claim 24, claim 25, claim 26, claim 27, claim 28, claim 29, claim 30, claim 31, claim 32, claim 33, claim 34, claim 36, claim 37, claim 38, claim 40, claim 41, claim 42, claim 43, claim 45, claim 46, claim 48, claim 50, claim 51 and claim 52 but with the linear members of the said device or devices being configured in dihedral or anhedral or polyhedral or gull-wing or curved polyhedral arrangement when viewed from the leading edge of the device or devices.

48. An improved and enhanced device as claimed in claim 1, claim 2, claim 3, claim 6, claim 7, claim 8, claim 9, claim 10, claim 11, claim 12, claim 13, claim 14, claim 16, claim 17, claim 18, claim 20, claim 21, claim 22, claim 24, claim 25, claim 32, claim 33, claim 34, claim 44 and claim 52 but with one or more linear members of the said device or devices being configured as a bridge or bridge like structure and which provides for pedestrian or vehicular traffic or rail traffic within the interior of one or more said linear members and said turbine or turbines as claimed in claim 1 or claim 2 or claim 3 or claim 4 or claim 5 positioned adjacent to Side A of said linear members or between two said linear members and adjacent to Side A of said linear members.

49. An improved and enhanced device made up of improved and enhance devices as claimed in claim 1, claim 2, claim 3, claim 6, claim 7, claim 8, claim 9, claim 10, claim 11, claim 12, claim 13, claim 14, claim 16, claim 17 and claim 18 but with two or more linear members of said devices attached to each other end to end such that the longitudinal axes of adjacent linear members converge with each other at an angle greater than plus or minus one degrees and such that two or more linear members enclose one or more of said turbines as claimed in claim 1 or claim 2 or claim 3 or claim 4 or claim 5 positioned adjacent to side A of said linear members.

50. An improved and enhanced device or devices as claimed in claim 1, claim 2, claim 3, claim 6, claim 7, claim 8, claim 9, claim 10, claim 11, claim 12, claim 13, claim 14, claim 16, claim 17 and claim 18 but with one or more linear members of said device or devices attached at one end to an adjacent object such as a building or other structure or vehicle, one or more of said turbines as claimed in claim 1 or claim 2 or claim 3 or claim 4 or claim 5 positioned adjacent to side A of said linear member or members.

51. An improved and enhanced device or devices as claimed in claim 20, claim 21, claim 22, claim 23, claim 32, claim 33, claim 34 and claim 35 but with the linear members of each improved and enhanced device attached at one end to an adjacent object such as a building or other structure or vehicle.

51. An improved and enhanced device or devices as claimed in claim 24, claim 25, claim 26, claim 27, claim 29 and claim 30 but with the linear members of said improved and enhanced devices attached at one end to an adjacent object such as a building or other structure or vehicle.

52. An improved and enhanced device as claimed in claim 1, claim 2, claim 3, claim 6, claim 7, claim 8, claim 9, claim 10, claim 11, claim 12, claim 13, claim 14, claim 15, claim 16, claim 17, claim 18, claim 19, claim 20, claim 21, claim 22, claim 23, claim 24, claim 25, claim 26, claim 27, claim 28, claim 29, claim 30, claim 31, claim 32, claim 33, claim 34, claim 35, claim 36, claim 37, claim 38, claim 39, claim 40, claim 41, claim 42, claim 43, claim 44, claim 45, claim 46, claim 47, claim 48, claim 49, claim 50 and claim 51 but the surface of Side A. and Side B the linear members said devices consists of a membrane or textile fabric material.

53. An improved and enhanced device or devices as claimed in claim 1, claim 2, claim 3, claim 6, claim 7, claim 8, claim 9, claim 10, claim 11, claim 12, claim 13, claim 14, claim 15, claim 16, claim 17, claim 18, claim 19, claim 20, claim 21, claim 22, claim 23, claim 24, claim 25, claim 26, claim 27, claim 28, claim 29, claim 30, claim 31, claim 32, claim 33, claim 34, claim 35, claim 36, claim 37, claim 38, claim 39, claim 40, claim 41, claim 42, claim 43, claim 44, claim 45, claim 46, claim 47, claim 48, claim 49, claim 50, claim 51 and claim 52 and substantially as hereinbefore described with or without reference to the drawings.
